(19) United States
(12) Patent Application Publication
(10) Pub. No.: US 2024/0280991 A1
(43) Pub. Date: Aug. 22, 2024

(54) INFORMATION PROCESSING APPARATUS, SYSTEM, METHOD, AND STORAGE MEDIUM

(71) Applicant: KABUSHIKI KAISHA TOSHIBA, Tokyo (JP)

(72) Inventors: Daisuke UCHIDA, Kawasaki Kanagawa (JP); Tomoya TANDAI, Ota Tokyo (JP); Koji AKITA, Yokohama Kanagawa (JP)

(73) Assignee: KABUSHIKI KAISHA TOSHIBA, Tokyo (JP)

(21) Appl. No.: 18/458,770

(22) Filed: Aug. 30, 2023

(30) Foreign Application Priority Data
Feb. 16, 2023 (JP) 2023-022375

(51) Int. Cl. G05D 1/02; G01S 13/931; H04W 4/44

(52) U.S. Cl. CPC G05D 1/028; G01S 13/931; H04W 4/44; G01S 2013/9316

(57) ABSTRACT

According to one embodiment, an information processing apparatus includes a processor configured to acquire information indicating a position of an antenna that radiates a control signal for controlling a moving vehicle using a radio wave, information indicating a position of an object in a space, and information indicating radio wave transmittance of the object, the radio wave transmittance indicating a degree of transmission of the radio wave through the object, and to evaluate a propagation environment of the radio wave in the space based on the information indicating the position of the antenna, the information indicating the position of the object, and the information indicating the radio wave transmittance of the object.

### CROSS-REFERENCE TO RELATED APPLICATIONS

This application is based upon and claims the benefit of priority from Japanese Patent Application No. 2023-022375, filed Feb. 16, 2023, the entire contents of which are incorporated herein by reference.

### FIELD

Embodiments described herein relate generally to an information processing apparatus, a system, a method, and a storage medium.

### BACKGROUND

In recent years, it is known to control a moving vehicle (for example, a mobile robot or the like) moving in a predetermined space by, for example, executing wireless communication. In this case, for example, the moving vehicle is controlled to move along a route from a start point to a goal point set on a map of a space where the moving vehicle moves.

Meanwhile, a control signal for controlling the moving vehicle is radiated from an antenna by a radio wave, but in a case where an object (hereinafter, described as an obstacle) is disposed in a space where the moving vehicle moves, there is a possibility that a propagation environment of the radio wave in a space (that is, a space behind the obstacle when viewed from the antenna) facing the antenna across the obstacle changes (that is, a dead region in which reception power deteriorates occurs) due to the obstacle.

When the moving vehicle moves in such a dead region, there is a possibility that the moving vehicle cannot normally receive the control signal. Therefore, it is desired to provide a mechanism that grasps a propagation environment of a radio wave that changes depending on an obstacle.

### BRIEF DESCRIPTION OF THE DRAWINGS

FIG. 1 is a diagram illustrating an example of a local 5G system applied to an embodiment.

FIG. 2 is a diagram illustrating an example of a target space.

FIG. 3 is a diagram illustrating an example of an environment assumed in the present embodiment.

FIG. 4 is a diagram illustrating an obstacle disposed in a target space.

FIG. 5 is a block diagram illustrating an example of a functional configuration of an information processing apparatus.

FIG. 6 is a diagram illustrating an example of a system configuration of the information processing apparatus.

FIG. 7 is a flowchart illustrating an example of a processing procedure of the information processing apparatus.

FIG. 8 is a diagram illustrating an example of a data structure of radio wave transmittance information.

FIG. 9 is a diagram illustrating a radio wave transmittance.

FIG. 10 is a diagram illustrating the radio wave transmittance.

FIG. 11 is a diagram illustrating map information output in the present embodiment.

FIG. 12 is a diagram illustrating the map information output in the present embodiment.

FIG. 13 is a diagram illustrating the map information output in the present embodiment.

FIG. 14 is a diagram illustrating a radio wave obliquely incident on an object from the air.

FIG. 15 is a diagram illustrating an example of a data structure of obstacle information.

FIG. 16 is a diagram illustrating another example of the data structure of the obstacle information.

FIG. 17 is a diagram illustrating a configuration using electrical conductivity, dielectric constant, and magnetic permeability with respect to temperature.

FIG. 18 is a diagram illustrating an example of processing of determining radio wave transmittance of an obstacle by classifying the obstacle.

FIG. 19 is a diagram illustrating an example of a reflection coefficient of a horizontally polarized wave.

FIG. 20 is a diagram illustrating an example of a reflection coefficient of a vertically polarized wave.

FIG. 21 is a diagram illustrating the reflection coefficient of the horizontally polarized wave when the obstacle is water.

FIG. 22 is a diagram illustrating the reflection coefficient of the vertically polarized wave when the obstacle is water.

FIG. 23 is a diagram illustrating an example of a method of estimating a dead region.

FIG. 24 is a diagram illustrating an example of the method of estimating the dead region.

FIG. 25 is a diagram illustrating an example of the method of estimating the dead region.

FIG. 26 is a diagram illustrating a configuration in which radio wave transmittance is changed based on an incident angle of a radio wave.

FIG. 27 is a diagram illustrating an example of a functional configuration of an information processing apparatus according to a modification of the present embodiment.

FIG. 28 is a diagram illustrating an example of a reception power map.

FIG. 29 is a diagram illustrating an example of a changed arrangement of obstacles.

FIG. 30 is a diagram illustrating another example of the changed arrangement of the obstacles.

### DETAILED DESCRIPTION

In general, according to one embodiment, an information processing apparatus includes a processor configured to acquire information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object, and to evaluate a propagation environment of the radio wave in the space based on the acquired information indicating the position of the antenna, the acquired information indicating the position of the object, and the acquired information indicating the radio wave transmittance of the object.

Various embodiments will be described with reference to the accompanying drawings.

An information processing apparatus according to the present embodiment is applied to a moving vehicle control system that controls a moving vehicle (a mobile robot) that moves in a predetermined space (hereinafter, referred to as a target space) such as a factory.

Hereinafter, a scenario assumed in the present embodiment will be described. In a case where a moving vehicle moves on a straight line along a passage in a target space, control on the moving vehicle may be simple, but for example, in a case where the passage arranged in the target space is curved or avoids an object (hereinafter, described as an obstacle) disposed in the target space, more advanced control is required.

Meanwhile, in a case where such control of the moving vehicle is performed by wire (that is, a control signal for controlling the moving vehicle is transmitted by wire), there are problems that a range in which the moving vehicle can move is limited, the control of the moving vehicle becomes impossible due to disconnection, and wiring work is complicated. Particularly, in a case where a large number of moving vehicles move in the target space, these problems become remarkable.

On the other hand, in a case where the control of the moving vehicle is wirelessly performed (that is, wireless control of the moving vehicle is performed), the above-described problem can be solved. For example, local 5G can be used for wireless control of such a moving vehicle. The local 5G is, for example, a 5G network that can be individually used by a company or the like, and is useful in an environment in which a large number of moving vehicles moving in a target space are wirelessly controlled because it is possible to realize high speed, low delay, and multiple simultaneous connections. It is noted that a wireless LAN can also be used for wireless control of the moving vehicle.

Here, the above-described moving vehicle can be roughly divided into one moving vehicle that operates autonomously and the other moving vehicle that operates based on a command from the outside (a control signal). The moving vehicle that autonomously operates is useful because each of the moving vehicles can operate by determining the situation, but the cost is high, and it is difficult to apply the moving vehicle to a case in which a large number of moving vehicles are disposed in the target space. On the other hand, as described above, in the case of the other moving vehicle that operates based on the command from the outside, it is possible to reduce the total cost of a system including the moving vehicle and a moving vehicle control apparatus by integrating the functions of controlling a large number of moving vehicles into one apparatus (the moving vehicle control apparatus). In addition, since it is possible to collectively manage information of a large number of moving vehicles moving in the target space, it is relatively easy to manage the moving vehicles. It is noted that capability of collectively grasping information on a large number of moving vehicles is also advantageous from a viewpoint of optimizing the movement of the entire moving vehicle.

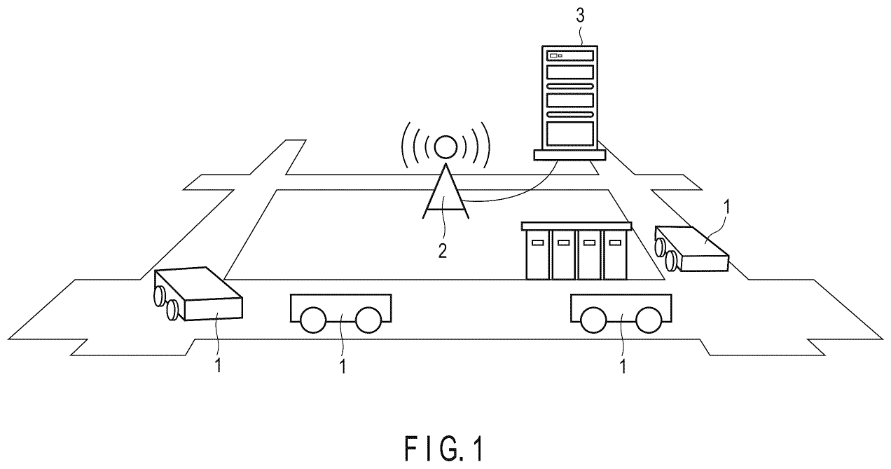

Hereinafter, as illustrated in FIG. 1, it is assumed that a local 5G system (cellular system) that performs terminal-side control on the base station side is applied to the present embodiment.

In the example illustrated in FIG. 1, a situation in which a plurality of moving vehicles (moving bodies) 1 move in a target space is assumed. Each of the plurality of moving vehicles 1 has a radio device mounted thereon and is communicably connected to a base station 2. Furthermore, a moving vehicle control apparatus 3 is connected to the base station 2, and control signals for controlling the moving vehicle 1, the control signals being generated by the moving vehicle control apparatus 3, are sequentially transmitted from the base station 2 (an antenna installed in the base station 2) to the moving vehicle 1, for example, at regular intervals. As a result, the moving vehicle 1 can move in the target space based on the control signals sequentially transmitted from the base station 2.

It is noted that FIG. 1 assumes a case in which the moving vehicle 1 is, for example, an autonomous mobile robot (AMR), and the moving vehicle control apparatus 3 is, for example, a server apparatus referred to as mobile edge computing (MEC). The moving vehicle control apparatus 3 may be a server apparatus that provides a cloud computing service.

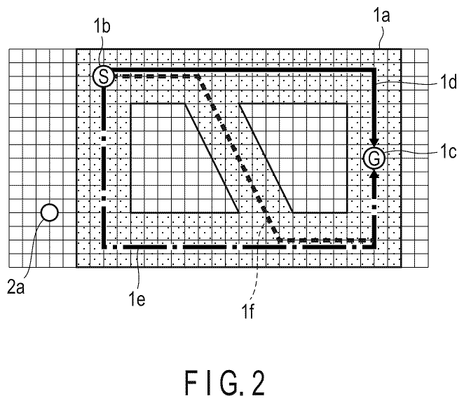

Here, it is assumed that the moving vehicle 1 is controlled to be movable in the target space illustrated in FIG. 2. Here, a situation in which the moving vehicle 1 moves from a start point 1b to a goal point 1c along a passage (for example, a traveling path provided in a factory or a warehouse) la in the target space in order to carry (convey) a load such as a cardboard box is considered.

In this case, as a route configured to allow the moving vehicle 1 to move from the start point 1b to the goal point 1c, there are a route 1d corresponding to the shortest route, a route 1e corresponding to the longest route, and a route 1f corresponding to an intermediate route with respect to the shortest route and the longest route.

According to the target space illustrated in FIG. 2, the route 1d (that is, the shortest route) is selected from among the routes 1d to 1f, thereby making it possible to control the moving vehicle 1 such that the moving vehicle 1 efficiently moves from the start point 1b to the goal point 1c. The control signal for controlling the moving vehicle 1 in this manner is radiated from, for example, an antenna 2a installed in the base station 2 to the moving vehicle 1. The antenna 2a is disposed, for example, in the target space. It is noted that, here, it has been described that the moving vehicle 1 moves from the start point 1b to the goal point 1c in order to carry a load, but such a load is not carried only once. For example, the moving vehicle 1 returns to the start point 1b again after carrying the previous load from the start point 1b to the goal point 1c, and repeatedly performs an operation of carrying another load from the start point 1b to the goal point 1c.

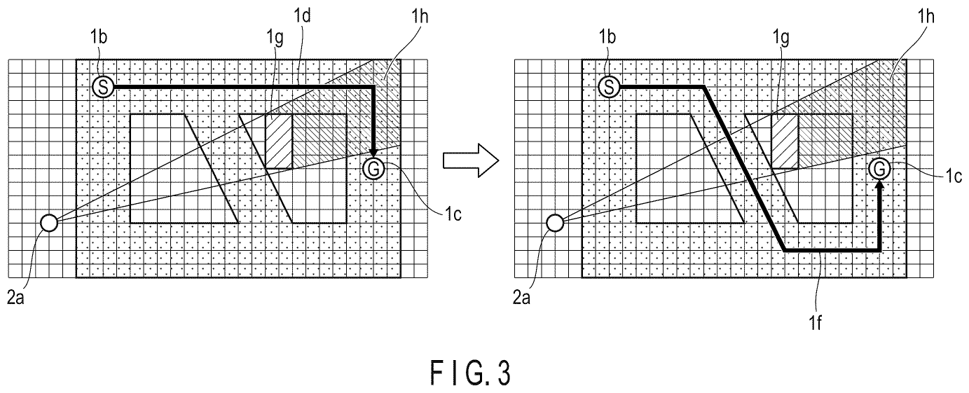

Here, in a case where the target space in which the moving vehicle 1 moves is, for example, a factory, a warehouse, or the like, it is assumed that the arrangement of obstacles (such as cardboard boxes carried by the moving vehicle 1) in the target space changes with the lapse of time. Here, as described above, for example, in a situation in which the moving vehicle 1 repeatedly carries a load from the start point 1b to the goal point 1c illustrated in FIG. 2 (that is, the plurality of moving vehicles 1 sequentially move along a determined route), it is assumed that an obstacle 1g is disposed in the target space as illustrated on the left side of FIG. 3.

When a signal (for example, the control signal or the like) is radiated from the antenna 2a by a radio wave and the obstacle 1g is a radio wave shielding object that shields a radio wave, such as metal (that is, for example, the obstacle is a cardboard box or the like in which a radio wave shielding object is packed), the radio wave radiated from the antenna 2a is shielded by the obstacle 1g, so that a propagation environment of the radio wave in a space 1h facing the antenna 2a with the obstacle 1g interposed between the antenna 2a and the space 1h deteriorates (that is, the dead region 1h in which reception power decreases occurs on the back side of the obstacle 1g when viewed from the antenna 2a).

In the example illustrated in FIG. 3, the space (that is, the dead region) 1h in which the propagation environment of the radio wave deteriorates overlaps the route 1d. Accordingly, when the moving vehicle 1 moves along the route 1d, there is a possibility that the moving vehicle 1 cannot normally receive the control signal in the dead region 1h. That is, the obstacle 1g disposed in the target space as described above becomes a factor that hinders efficient movement (control) of the moving vehicle 1.

In a case where the dead region 1h occurs in this manner, for example, by changing the route 1d to the route 1f (an intermediate route) as illustrated on the right side of FIG. 3, the moving vehicle 1 can be controlled to avoid the dead region 1h.

However, in order to change the route 1d to the route 1f as described above, for example, the moving vehicle 1 needs to move (that is, the reception power in the dead region 1h is measured) to the dead region 1h at least once, and to detect (grasp) the occurrence of the dead region 1h. In this case, there is a possibility that the moving vehicle 1 cannot appropriately receive the control signal in the dead region 1h, and as such the moving vehicle 1 does not normally operate (for example, the operation stops). Furthermore, movement of the moving vehicle 1 in the dead region 1h may cause an accident or the like due to the inability to appropriately receive a control signal (that is, an instruction to change the moving speed of the moving vehicle 1 and the moving direction thereof, and the like).

For this reason, it is desired to provide a mechanism capable of grasping the dead region 1h generated by the obstacle 1g disposed in the target space without movement of the moving vehicle 1 in the dead region 1h.

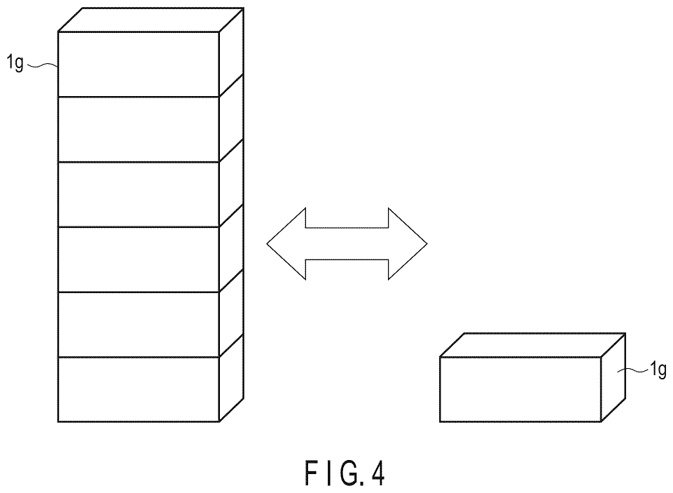

It is noted that, as described above, in a situation where the moving vehicle 1 moves in the target space such as a factory or a warehouse, for example, there is a case in which the obstacle 1g having a plurality of cardboard boxes for packing radio wave shielding objects stacked in the height direction (that is, the cardboard boxes are vertically loaded) is disposed, and the height of the obstacle 1g changes when the cardboard boxes are removed or further stacked. It is considered that whether the dead region 1h occurs (that is, the propagation environment of the radio wave) depends on the height of such an obstacle 1g. Specifically, for example, in the case of the obstacle 1g having a large number of cardboard boxes stacked in the height direction as illustrated on the left side of FIG. 4, the dead region 1h occurs by the obstacle 1g, but in the case where the number of cardboard boxes of the obstacle 1g is reduced as illustrated on the right side of FIG. 4, the influence of the obstacle 1g is reduced, and the dead region 1h does not occur.

In addition, the obstacle 1g is a loaded cardboard box, and the influence of the obstacle 1g fluctuates depending on contents (that is, components constituting the obstacle 1g) of the cardboard box, and whether the dead region 1h occurs fluctuates. For example, when a component constituting the obstacle 1g is metal, the obstacle 1g becomes a radio wave shielding object, and there is a high possibility that the dead region 1h occurs. On the other hand, even in the case where the obstacle 1g is a loaded cardboard box, when the cardboard box is empty or when a content (that is, the component constituting the obstacle 1g) of the cardboard box is glass, plastic, or the like, the obstacle 1g does not become a radio wave shielding object, and there is a low possibility that the dead region 1h occurs.

That is, in order to grasp the dead region 1h without movement of the moving vehicle 1 in the dead region 1h as described above, it is necessary to grasp whether an obstacle disposed in a target space is a radio wave shielding object.

Therefore, in the present embodiment, an information processing apparatus useful for grasping (estimating) a propagation environment (for example, occurrence of a dead region) of a radio wave in a target space (a space where the moving vehicle 1 moves) will be described.

It is noted that the information processing apparatus according to the present embodiment is assumed to be an apparatus prepared separately from the moving vehicle control apparatus 3 that controls the moving vehicle 1 described above, and the moving vehicle control system according to the present embodiment is assumed to include the information processing apparatus described below in addition to the moving vehicle 1 and the moving vehicle control apparatus 3 described above.

FIG. 5 is a block diagram illustrating an example of a functional configuration of the information processing apparatus according to the present embodiment. As illustrated in FIG. 5, an information processing apparatus 4 includes a processor 41, a storage 42, an acquisition unit 43, and an output unit 44. Furthermore, the processor 41 includes a management module 41a, an evaluation module 41b, and a map information processing module 41c.

The management module 41a manages map information indicating a map of a target space, arrangement plan information indicating an arrangement plan of obstacles (objects) in the target space, movement plan information indicating a movement plan of a moving vehicle in the target space, and the like. The map information, the arrangement plan information, and the movement plan information managed by the management module 41a are stored in the storage 42.

In addition, it is assumed that the storage 42 stores radio wave transmittance information including radio wave transmittance of an obstacle disposed in a target space, the radio wave transmittance indicating a degree of transmission of the radio wave through the object.

The evaluation module 41b evaluates a propagation environment of a radio wave in a target space based on the map information, the arrangement plan information, and the radio wave transmittance information managed by the management module 41a. It is noted that the evaluation module 41b may evaluate a propagation environment of a radio wave in a partial region in the target space with reference to, for example, the movement plan information managed by the management module 41a. Details of the evaluation by the evaluation module 41b will be described later.

The map information processing module 41c acquires the map information stored in the storage 42, and executes processing of adding an evaluation result by the evaluation module 41b to the map information.

The acquisition unit 43 acquires the map information, the arrangement plan information, and the movement plan information managed by the management module 41a. It is noted that the map information, the arrangement plan information, and the movement plan information may be acquired (received) from an external device such as the moving vehicle control apparatus 3, or may be acquired according to an operation of an administrator or the like of the information processing apparatus 4 (the moving vehicle control system).

The output unit 44 outputs (transmits) the map information to which the evaluation result is added by the map information processing module 41c.

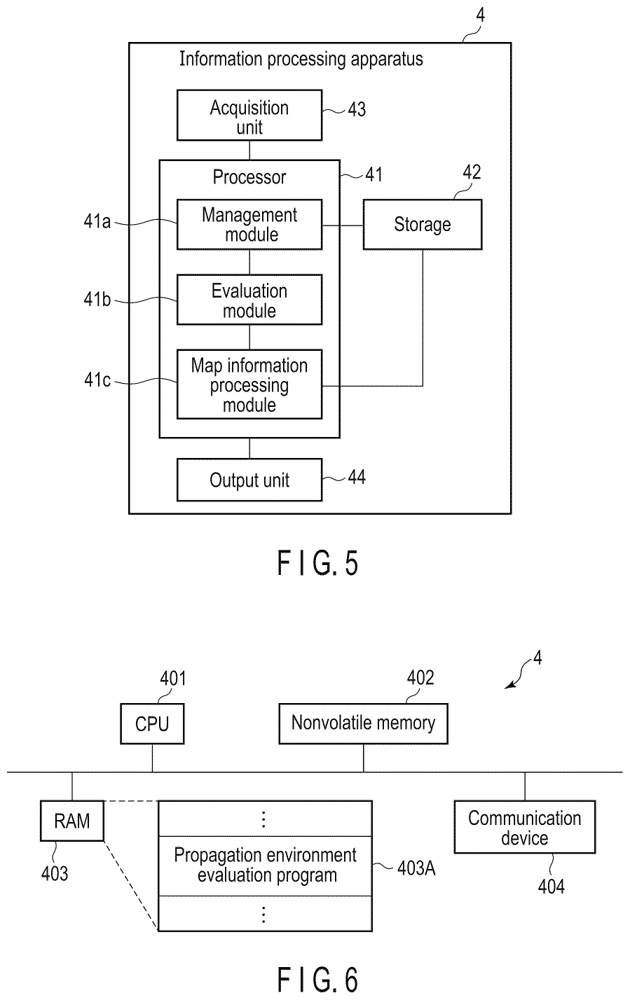

FIG. 6 illustrates an example of a system configuration of the information processing apparatus 4 illustrated in FIG. 5. The information processing apparatus 4 includes a CPU 401, a nonvolatile memory 402, an RAM 403, a communication device 404, and the like.

The CPU 401 is a processor configured to control operations of various components in the information processing apparatus 4. The CPU 401 may be a single processor or may include a plurality of processors. The CPU 401 executes various programs loaded from the nonvolatile memory 402 to the RAM 403. These programs include various application programs such as an operating system (OS) and a propagation environment evaluation program 403A for evaluating a propagation environment of a radio wave as described above.

The nonvolatile memory 402 is a storage medium used as an auxiliary storage device. The RAM 403 is a storage medium used as a main storage device. Although only the nonvolatile memory 402 and the RAM 403 are illustrated in FIG. 6, the information processing apparatus 4 may include other storage devices such as a hard disk drive (HDD) and a solid state drive (SSD).

The communication device 404 is a device configured to perform wired communication or wireless communication.

In the present embodiment, the processor 41 illustrated in FIG. 5 is implemented by at least one processor. The processor includes, for example, a control device and an arithmetic device, and is implemented by an analog or digital circuit or the like. The processor may be the CPU 401 described above, or may be a general-purpose processor, a microprocessor, a digital signal processor (DSP), an ASIC, an FPGA, or a combination thereof.

In addition, a part or all of the processor 41 can be implemented by allowing the CPU 401 (that is, the computer of the information processing apparatus 4) to execute the propagation environment evaluation program 403A, that is, by software. The propagation environment evaluation program 403A may be stored in a computer-readable storage medium and distributed, or may be downloaded to the information processing apparatus 4 via a network. It is noted that a part or all of the processor 41 may be implemented by dedicated hardware or the like, or may be implemented by a combination of software and hardware.

In the present embodiment, the storage 42 illustrated in FIG. 5 is implemented by, for example, the nonvolatile memory 402 or another storage device. Furthermore, in the present embodiment, the acquisition unit 43 (reception unit) and the output unit 44 (transmission unit) illustrated in FIG. 5 are implemented by, for example, the communication device 404.

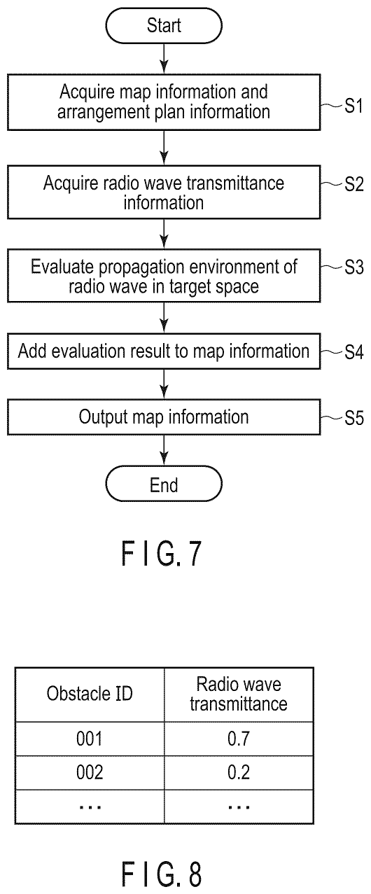

Hereinafter, an example of a processing procedure of the information processing apparatus 4 according to the present embodiment will be described with reference to a flowchart in FIG. 7. It is noted that, for example, the processing illustrated in FIG. 7 is assumed to be executed at a timing of being instructed by an administrator of the information processing apparatus 4.

First, the management module 41a included in the processor 41 acquires, from the storage 42, map information and arrangement plan information stored in the storage 42 (step S1).

It is noted that the map information acquired in step S1 indicates a map of a target space in which the moving vehicle 1 moves, and (information indicating) a position of an antenna that radiates a control signal for controlling the moving vehicle 1 is registered (set) in the map (information).

In addition, it is assumed that the arrangement plan information acquired in step S1 indicates an arrangement plan of an obstacle in the target space, and for example, (information indicating) positions of obstacles dynamically disposed in the target space is registered (set) in the arrangement plan information. It is noted that the positions of the obstacles dynamically disposed include a position of an obstacle to be disposed, a position of an obstacle currently disposed in the target space, and the like.

The position of the antenna registered in the map information and the position of the obstacle registered in the arrangement plan information are represented by coordinate values or the like defined on the map indicated by the map information.

Next, the management module 41a acquires, from the storage 42, radio wave transmittance information indicating radio wave transmittance of the obstacle disposed in the target space (step S2).

Here, FIG. 8 illustrates an example of a data structure of the radio wave transmittance information. As illustrated in FIG. 8, the radio wave transmittance information includes an obstacle ID and radio wave transmittance in association with each other.

The obstacle ID is an identifier assigned to the obstacle disposed in the target space. The radio wave transmittance is radio wave transmittance of an obstacle to which the obstacle ID associated with the radio wave transmittance is allocated. That is, in the present embodiment, the radio wave transmittance information can be said to be information in which an obstacle and radio wave transmittance are associated with each other.

It is noted that the radio wave transmittance indicates a degree of transmission of the radio wave through the object, but when the obstacle is a load such as a cardboard box, the radio wave transmittance varies depending on a substance (hereinafter, referred to as a component of an obstacle) constituting the obstacle. Therefore, in the present embodiment, the radio wave transmittance included in the radio wave transmittance information is assumed to be radio wave transmittance for a main component (a dominant substance among substances constituting the obstacle) of the obstacle. It is noted that the “main component of the obstacle” refers to, for example, a component, the proportion of which in (a plurality of substances constituting) the obstacle is a predetermined value or more.

In the example illustrated in FIG. 8, the radio wave transmittance information includes an obstacle ID “001” and a radio wave transmittance “0.7” in association with each other. This radio wave transmittance information indicates that (the main component of) the obstacle to which the obstacle ID “001” is allocated has radio wave transmittance of 0.7.

Further, the radio wave transmittance information also includes an obstacle ID “002” and radio wave transmittance “0.2” in association with each other. This radio wave transmittance information indicates that (the main component of) the obstacle to which the obstacle ID “002” is allocated has radio wave transmittance of 0.2.

Although only the radio wave transmittance information including the radio wave transmittance of the obstacles to which the obstacle IDs “001” and “002” are allocated is illustrated in FIG. 8, it is assumed that the radio wave transmittance information is stored in the storage 42 for each obstacle disposed in the target space.

When the obstacle is constituted by a plurality of components, the obstacle ID and the radio wave transmittance may be set and stored as the radio wave transmittance information with the plurality of components as one component. Among the plurality of components, the radio wave transmittance may be represented by a component having the highest radio wave transmittance, a component having the lowest radio wave transmittance, an average value or a median of the radio wave transmittances, weighting with a ratio of the components, or the like.

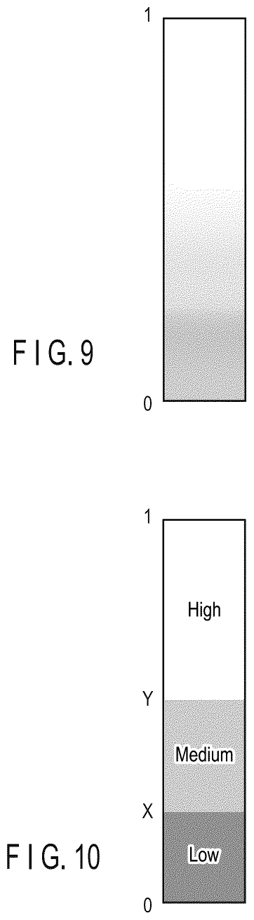

Here, the radio wave transmittance in the present embodiment will be described with reference to FIG. 9. As illustrated in FIG. 9, the radio wave transmittance is, for example, a continuous numerical value between 0 to 1. In this case, in the radio wave transmittance, a numerical value closer to 0 indicates that a radio wave is not transmitted, and a numerical value closer to 1 indicates that a radio wave is transmitted.

Here, it has been described that the radio wave transmittance is a continuous numerical value between 0 to 1, but for example, the radio wave transmittance may be represented stepwise using a plurality of threshold values (predetermined values), as illustrated in FIG. 10. In the example illustrated in FIG. 10, for example, a case in which the radio wave transmittance is 0 or more and less than X is treated as a case in which the radio wave transmittance is “low”, a case in which the radio wave transmittance is Y or more and 1 or less is treated as a case in which the radio wave transmittance is “high”, and a case in which the radio wave transmittance is X or more and less than Y is treated as a case in which the radio wave transmittance is “medium”. It is noted that X and Y in FIG. 10 are numerical values between 0 to 1 used as threshold values, and satisfy the relationship of X<Y.

Referring back to FIG. 7 again, the evaluation module 41b evaluates the propagation environment of the radio wave in the target space based on the position of the antenna registered in the map information acquired in step S1, the position of the obstacle registered in the arrangement plan information acquired in step S1, and the radio wave transmittance (that is, the radio wave transmittance included in the radio wave transmittance information in association with the obstacle ID allocated to the obstacle disposed in the target space) of the obstacle indicated by the radio wave transmittance information acquired in step S2 (step S3).

It is noted that, in step S3, for example, the propagation environment of the radio wave is evaluated for each region (hereinafter, referred to as a target region) obtained by dividing the target space into a lattice shape in plan view. According to such processing in step S3, it is evaluated (determined) whether each target region corresponds to a dead region generated, for example, by disposing an obstacle.

Specifically, for example, when no obstacle is disposed between the target region and the antenna, it is considered that the radio wave (the signal) radiated from the antenna reaches (the moving vehicle 1 moving through) the target region, thereby making it possible to obtain an evaluation result indicating that the target region is not a dead region.

On the other hand, when an obstacle is disposed between the target region and the antenna and the radio wave transmittance of the obstacle is low (for example, the radio wave transmittance is less than a predetermined value or the radio wave transmittance is “low”), it is considered that the radio wave radiated from the antenna does not reach the target region (shielded by the obstacle), thereby making it possible to obtain an evaluation result indicating that the target region (that is, a region facing the antenna with the obstacle interposed between the region and the antenna) is a dead region.

It is noted that even when an obstacle is disposed between the target region and the antenna, if the radio wave transmittance of the obstacle is high (for example, the radio wave transmittance is a predetermined value or more, or the radio wave transmittance is “high”), it is considered that the radio wave radiated from the antenna passes through the obstacle and reaches (the moving vehicle 1 moving through) the target region, thereby making it possible to obtain an evaluation result indicating that the target region is not a dead region.

Here, the description has been given assuming that an evaluation result of whether a region is a dead region is obtained for each target region by executing the processing in step S3, but the evaluation result may be based on different indexes. Specifically, the evaluation result may be, for example, reception power (intensity of a radio wave) in a target region or an arrival rate of a radio wave to the target region calculated based on the radio wave transmittance of the obstacle in consideration of a relationship among the position of the antenna, the position of the obstacle, and the position of the target region. In addition, the target region may be set in a shape other than the lattice shape.

In the present embodiment, it is possible to estimate (specify) a dead region in a target space based on the above-described evaluation result. In this case, a region mainly on the back surface of the obstacle having low radio wave transmittance is estimated as a dead region.

As described above, whether the dead region occurs depends on the height of the obstacle. In this case, the arrangement plan information described above may include (information on) the height of the obstacle in addition to the position of the obstacle. According to this configuration, for example, it is possible to estimate, as a dead region, a region on the back surface of an obstacle, the radio wave transmittance of which is low and the height of which is high (a predetermined value or more).

Next, the map information processing module 41c adds the evaluation result (for example, information such as the estimated position of the dead region) in step S3 to the map information acquired in step S1 (step S4). In a case where the processing in step S4 is executed, for example, map information indicating a map on which a region estimated as a dead region and a region not estimated as a dead region are mapped is obtained.

When the processing in step S4 is executed, the output unit 44 outputs the map information (that is, the map information to which the evaluation result is added) obtained by executing the processing in step S4 (step S5).

It is noted that the map information output in step S5 may be transmitted to, for example, an apparatus outside the information processing apparatus 4 (for example, the moving vehicle control apparatus 3 and the like). According to such a configuration, for example, the moving vehicle control apparatus 3 can execute processing of controlling the moving vehicle 1 (changing a movement plan) based on the map information transmitted from the information processing apparatus 4.

Here, it has been described that the map information output in step S5 is used for controlling the moving vehicle 1 moving in the target space, but the map information may be used for other purposes. Specifically, the map information output in step S5 may be displayed on, for example, a display device (display) included in the information processing apparatus 4. According to such a configuration, for example, an administrator of the information processing apparatus 4 can recognize a dead region generated by the arrangement of obstacles in real time by referring to the map information displayed on the display device (a map obtained by mapping a region estimated as the dead region and a region not estimated as the dead region).

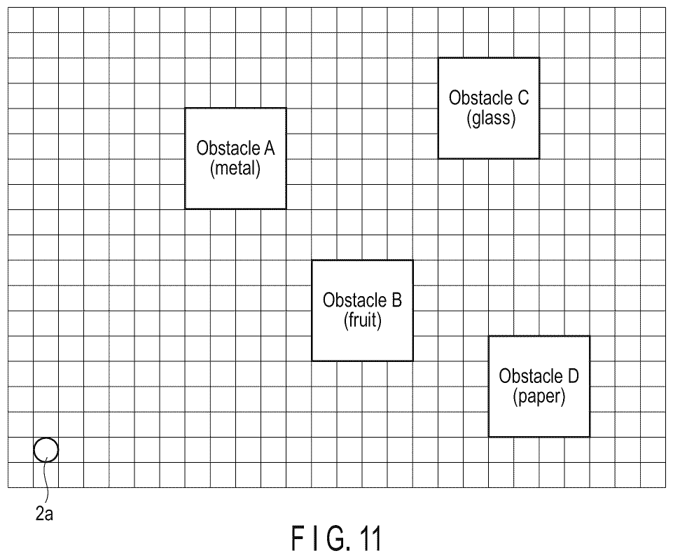

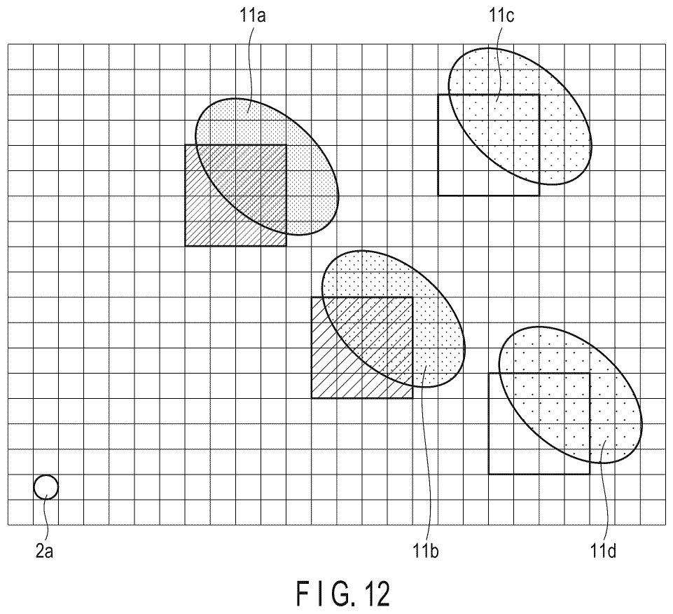

Here, the map information output in step S5 will be described with reference to FIGS. 11 and 12. FIG. 11 illustrates an example of arrangement of obstacles in a target space. In the example illustrated in FIG. 11, it is assumed that obstacles A to D are disposed in the target space.

It is assumed that the obstacle A is a cardboard box mainly having metal packed therein, and the radio wave transmittance thereof is “low”. In addition, it is assumed that the obstacle B is a cardboard box mainly having fruits packed therein, and the radio wave transmittance thereof is “medium”. Further, it is assumed that the obstacle C is a cardboard box mainly having glass packed therein, and the radio wave transmittance thereof is “high”. In addition, it is assumed that the obstacle D is a cardboard box mainly having paper packed therein, and the radio wave transmittance thereof is “high”. It is noted that the antenna 2a installed in the base station 2 is assumed to be disposed at a lower left position in FIG. 11.

FIG. 12 illustrates an example of (the map indicated by) the map information output in step S5 when the obstacles A to D are disposed in the target space as illustrated in FIG. 11.

In this case, in the map information illustrated in FIG. 12, for example, a region (that is, a region on the back side of the obstacle A when viewed from the antenna 2a) 11a facing the antenna 2a with the obstacle A interposed between the region 11a and the antenna 2a is represented as a dead region. Similarly, a region (that is, a region on the back side of the obstacle B when viewed from the antenna 2a) 11b facing the antenna 2a with the obstacle B interposed between the region 11b and the antenna 2a is represented as a dead region. Meanwhile, a region (that is, a region on the back side of the obstacle C when viewed from the antenna 2a) 11c facing the antenna 2a with the obstacle C interposed between the region 11c and the antenna 2a is not represented as a dead region. Further, a region (that is, a region on the back side of the obstacle D when viewed from the antenna 2a) 11d facing the antenna 2a with the obstacle D interposed between the region 11d and the antenna 2a is not represented as a dead region. Although both the regions 11a and 11b are the dead regions, the regions 11a and 11b are hatched according to the radio wave transmittance of each of the obstacles A and B. Similarly, although the regions 11c and 11d are not the dead regions, the regions 11c and 11d are hatched according to the radio wave transmittance of each of the obstacles C and D.

In such map information, since a dead region generated according to an obstacle is displayed on a map of a target space, it can be said that the map information is useful for grasping a propagation environment (occurrence of the dead region) of a radio wave in the target space.

In addition, FIG. 12 illustrates map information to which the position of an obstacle registered in the arrangement plan information and the radio wave transmittance of the obstacle are added in addition to the evaluation results described above. According to such map information, it is possible to grasp the position of the obstacle that has caused a dead region and the radio wave transmittance of the obstacle together. However, at least the evaluation result may be added to the map information output in the present embodiment.

It is noted that, in FIG. 7, the description has been given assuming that the propagation environment of the radio wave is evaluated for all the target regions (all the regions obtained by dividing the target space into a lattice shape) in the target space. However, since a possibility that a region where an obstacle is not disposed becomes a dead region is lower than a possibility that a region where an obstacle is disposed becomes a dead region, a propagation environment of a radio wave may be evaluated using only a region, as a target region, facing the antenna 2a with the obstacle interposed therebetween.

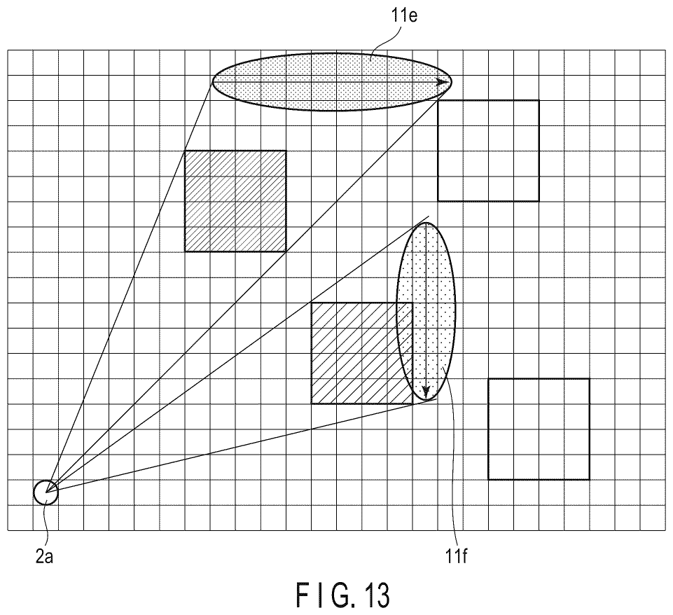

Furthermore, the target region in which the propagation environment of the radio wave is evaluated may be determined based on, for example, the movement plan information stored in the storage 42. Specifically, the movement plan information indicates a movement plan of the moving vehicle 1 moving in the target space, and the movement plan includes a route along which the moving vehicle 1 is scheduled to move. In this case, the propagation environment of the radio wave may be evaluated using only a region, as a target region, corresponding to the route included in the movement plan (the route along which the moving vehicle 1 is scheduled to move). According to this configuration, for example, as illustrated in FIG. 13, in a case where the obstacles A and B, the radio wave transmittance of which is less than a predetermined value, are located between a route along which the moving vehicle 1 moves and the antenna 2a, it is possible to output the map information obtained by mapping the fact that regions 11e and 11f on the route are dead regions.

It is noted that, in the present embodiment, a configuration in which map information to which at least an evaluation result is added is output is assumed as described above, but for example, from a viewpoint of information useful for grasping occurrence of a dead region and the like, a configuration in which the evaluation result itself (for example, coordinate values of the region estimated as the dead region and the like) is output instead of the map information may be used.

Furthermore, in the present embodiment, it has been described that the map information to which the evaluation result indicating whether the target region is the dead region is added is output. However, in the present embodiment, for example, map information to which a combination of a position at which an obstacle is disposed in a target space and radio wave transmittance of the obstacle is added may be output. Even with such map information, it is considered that an administrator can grasp, for example by referring to the map information, that there is a high possibility that a region on the back side of an obstacle (for example, the obstacle A) having low radio wave transmittance when viewed from the antenna 2a is a dead region.

It is noted that, in step S1 illustrated in FIG. 7, it has been described that the arrangement plan information (that is, the position of the obstacles dynamically disposed in the target space) is acquired from the storage 42, but the position of the obstacle may be acquired (received) from an external device. Specifically, for example, in a case where a load such as a cardboard box carried by the moving vehicle 1 is an obstacle, a carrying destination (that is, a goal point) of the load can be acquired as a position of the obstacle. It is noted that a correspondence relationship between (a moving vehicle ID allocated to) the moving vehicle 1 and (a load ID allocated to) the load carried by the moving vehicle 1 is managed in a movement plan, an arrangement plan, or the like. It is noted that a load carried by the moving vehicle 1 may be managed using a sensor, an RFID tag, or the like attached to the load. In this case, the processing illustrated in FIG. 7 may be executed, for example, at a timing when a load is moved (that is, the arrangement of obstacles has been changed).

Furthermore, the position of the obstacle (the load) described above may be input to the information processing apparatus 4 by an administrator. In this case, the processing illustrated in FIG. 7 may be executed, for example, when the position of the obstacle is input (that is, the position of the obstacle has been changed) to the information processing apparatus 4 by the administrator.

It is noted that, in the example of the map information illustrated in FIG. 12, the regions 11a and 11b are dead regions, and the regions 11c and 11d are not dead regions. This is an example of the evaluation result, and does not always indicate that a region near an obstacle, the radio wave transmittance of which is “low” or “medium”, is a dead region, and a region near an obstacle, the radio wave transmittance of which is “high”, is not a dead region.

Here, in the present embodiment, it has been described that a propagation environment of a radio wave is evaluated using radio wave transmittance of an obstacle disposed in a target space, and the radio wave transmittance thereof will be described in detail below.

First, the radio wave transmittance of an obstacle is an index related to evaluation of whether the obstacle is a radio wave shielding object (an object that shields a radio wave). Whether the obstacle is the radio wave shielding object is determined by how the radio wave is affected (whether the radio wave is reflected or transmitted) when the radio wave hits the obstacle.

Here, a reflection coefficient Γ representing a degree of reflection of a radio wave at a boundary surface between air and an obstacle when the radio wave is perpendicularly incident on an object such as the obstacle from the air is calculated as in the following Formula (1).

$$Γ = \frac{Z - {Z}_{0}}{Z + {Z}_{0}} \qquad ( 1 )$$

Similarly, a transmission coefficient T representing a degree of transmission of a radio wave through a boundary surface between air and an obstacle when the radio wave is perpendicularly incident on an object from the air is calculated as in the following Formula (2).

$$T = \frac{2 Z}{Z + {Z}_{0}} \qquad ( 2 )$$

It is noted that Z₀ and Z in the above-described Formulas (1) and (2) are characteristic impedances of the air and the object, respectively. In this case, Z₀ is given as Formula (3).

$${Z}_{0} = \sqrt{\frac{{μ}_{0}}{{ε}_{0}}} = 377 Ω \qquad ( 3 )$$

In addition, Z is given as in Formula (4).

$$Z = \sqrt{\frac{μ}{ε}} \qquad ( 4 )$$

Here, dielectric constant ε=εᵣε₀, and magnetic permeability μ=μᵣμ₀. εᵣ represents relative dielectric constant, and μᵣ represents relative magnetic permeability. When Z=Z₀, “the reflection coefficient T=0” is obtained by Formula (1), and “the transmission coefficient T=1” is obtained by Formula (2). In this case, the object (obstacle) does not become a radio wave shielding object. For example, when ε=ε₀ and μ=μ₀ (that is, εᵣ=1 and μᵣ=1), Z=Z₀.

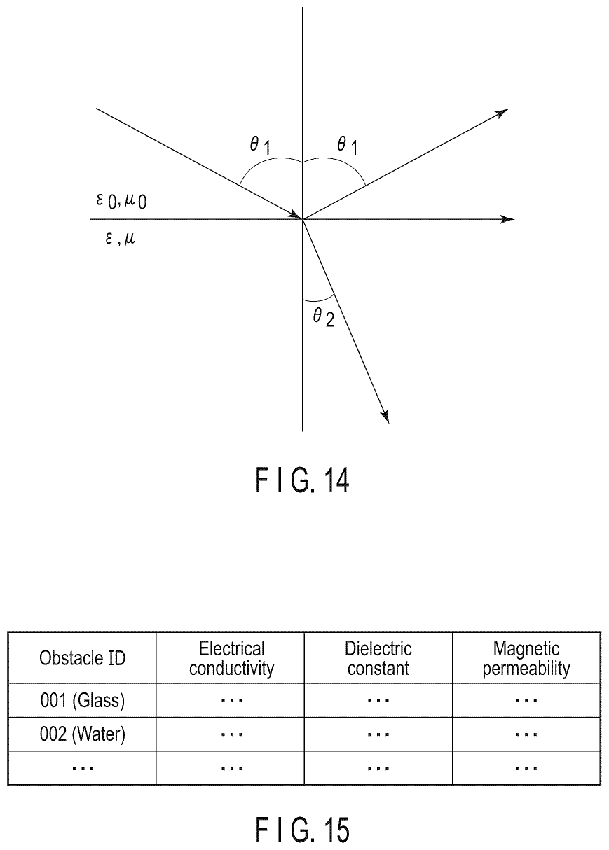

Next, a case in which a radio wave is obliquely incident on an object from the air is considered with reference to FIG. 14. In FIG. 14, an arrow extending in the horizontal direction represents a boundary surface between air (ε₀, μ₀) and an object (ε, μ).

When an incident angle of a radio wave and a polarized wave in the radio wave (a horizontally polarized wave and a vertically polarized wave) are considered, reflection coefficients R_{H} and R_{V} with respect to the horizontally polarized wave and the vertically polarized wave are calculated as in the following Formulas (5) and (6).

$${R}_{H} = \frac{cos {θ}_{1} - \sqrt{{n}^{2} - {sin}^{2} {θ}_{1}}}{cos {θ}_{1} + \sqrt{{n}^{2} - {sin}^{2} {θ}_{1}}} \qquad ( 5 )$$

$${R}_{V} = \frac{{n}^{2} cos {θ}_{1} - \sqrt{{n}^{2} - {sin}^{2} {θ}_{1}}}{{n}^{2} cos {θ}_{1} + \sqrt{{n}^{2} - {sin}^{2} {θ}_{1}}} \qquad ( 6 )$$

Transmission coefficients T_{H} and T_{V} for the horizontally polarized wave and the vertically polarized wave are calculated as in the following Formulas (7) and (8).

$${T}_{H} = \frac{2 cos {θ}_{1}}{cos {θ}_{1} + \sqrt{{n}^{2} - {sin}^{2} {θ}_{1}}} \qquad ( 7 )$$

$${T}_{V} = \frac{2 {n}^{2} cos {θ}_{1}}{{n}^{2} cos {θ}_{1} + \sqrt{{n}^{2} - {sin}^{2} {θ}_{1}}} \qquad ( 8 )$$

In the Formulas (5) to (8), 01 represents an incident angle, and n represents a refractive index of an object. That is, when the incident angle θ₁ is fixed, the refractive index n becomes parameters of the reflection coefficients R_{H} and R_{V} and the transmission coefficients T_{H} and T_{V}.

Here, a light velocity c is expressed using 80 and wo as in the following Formula (9).

$$C = \frac{1}{\sqrt{{ε}_{0} {μ}_{0}}} \qquad ( 9 )$$

Furthermore, as in the following Formula (10), the refractive index n is expressed by a ratio of the light velocity c and a velocity v in the object.

$$n = \frac{C}{V} \qquad ( 10 )$$

Furthermore, the velocity v in the object is expressed as in the following Formula (11).

$$V = \frac{1}{\sqrt{εμ}} \qquad ( 11 )$$

When the above-described Formulas (9) and (11) are applied to Formula (10), the refractive index n is expressed by using the relative dielectric constant εᵣ and the relative magnetic permeability μᵣ as in Formula (12).

$$n = \sqrt{\frac{εμ}{{ε}_{0} {μ}_{0}}} = \sqrt{{ε}_{r} {μ}_{r}} \qquad ( 12 )$$

As described above, a reflection coefficient (hereinafter, referred to as a reflection coefficient of an object) when a radio wave is reflected by a surface of an object (a boundary surface between the air and the object) and a transmission coefficient (hereinafter, referred to as a transmission coefficient of the object) when the radio wave is transmitted through the surface of the object are determined by relative dielectric constant and relative magnetic permeability of the object.

Here, when an object is regarded as a lossy medium, the lossy medium is divided into a conductive loss medium, a dielectric loss medium, and a magnetic loss medium. Among them, a medium in which conductivity and dielectricity should be considered at the same time includes electrical conductivity as complex dielectric constant and is treated as in the following Formula (13).

$$ε = {ε}^{′} - j {ε}^{″} - {ε}^{′} - j \frac{σ}{ω} \qquad ( 13 )$$

In Formula (13), ε′ is a dielectric constant real part, j is an imaginary unit, σ is an electrical conductivity, and ω is an angular frequency. For example, the electrical conductivity σ of copper is on the order of 10⁷, and ω is on the order of 10⁶ to 10⁹ when a radio wave irradiated to copper is a microwave. On the other hand, the dielectric constant actual part ε′ is on the order of 10⁻¹², which is much smaller than the electrical conductivity σ and the angular frequency ω. In this case, Formula (13) can be approximated as in the following Formula (14).

$$ε \approx - j \frac{σ}{ω} \qquad ( 14 )$$

As described above, electrical conductivity, dielectric constant (relative dielectric constant), and magnetic permeability (relative magnetic permeability) contribute to a reflection coefficient and a transmission coefficient of an object, and whether the object is a radio wave shielding object is determined by the reflection coefficient and the transmission coefficient. In other words, it can be said that radio wave transmittance of an object can be determined based on electrical characteristics and magnetic characteristics of the object, such as electrical conductivity, dielectric constant, and magnetic permeability.

In the present embodiment, for example, as described above, the radio wave transmittance information including the radio wave transmittance determined based on the electrical characteristics and the magnetic characteristics (electrical conductivity, dielectric constant, and magnetic permeability) of the object that can be an obstacle may be stored in advance in the storage 42. However, in the present embodiment, for example, obstacle information indicating the electrical characteristics and the magnetic characteristics of the obstacle may be stored in advance in the storage 42 instead of the radio wave transmittance. In this case, instead of the processing in step S2 illustrated in FIG. 7, processing of calculating (determining) the radio wave transmittance of the obstacle based on the electrical characteristics and the magnetic characteristics indicated by the obstacle information may be executed. In this case, the radio wave transmittance can be calculated based on, for example, the reflection coefficient or the transmission coefficient obtained from the electrical conductivity, the dielectric constant, and the magnetic permeability described above.

As described above, an obstacle (an object) such as a load disposed in a target space (a factory, a warehouse, or the like) is often a mixture of a plurality of substances, and it is complicated to obtain (information of) the electrical conductivity, the dielectric constant, and the magnetic permeability in consideration of each of the plurality of substances. In the present embodiment, it is sufficient if it is possible to grasp whether the obstacle can transmit the radio wave as a whole, and thus, as shown in FIG. 15, the obstacle information described above may have a data structure that includes the electrical conductivity, the dielectric constant, and the magnetic permeability of the main components of the obstacle to which the obstacle ID is allocated in association with the obstacle ID.

The electrical conductivity, the dielectric constant, and the magnetic permeability included in the obstacle information may be obtained by measurement. For example, the dielectric constant can be obtained by applying a measurement method using radio waves such as microwaves or millimeter waves or a measurement method (an impedance measurement method) of applying an AC voltage or an AC current.

Furthermore, it is known that the electrical conductivity, the dielectric constant, and the magnetic permeability of an object change depending on the temperature of the object. The relative dielectric constant εᵣ with respect to temperature t of water is given by the following Formula (15).

$${ε}_{r} ( t ) = 88.15 - 0.414 t + 0.131 \times {10}^{- 2} {t}^{2} - 0.046 \times {10}^{- 4} {t}^{3} \qquad ( 15 )$$

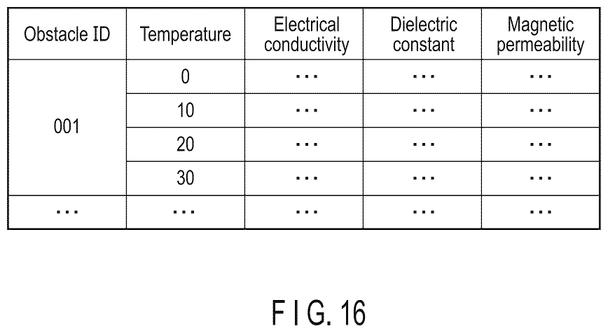

Therefore, as illustrated in FIG. 16, the obstacle information may have a data structure including, for example, the electrical conductivity, the dielectric constant, and the magnetic permeability with respect to temperature.

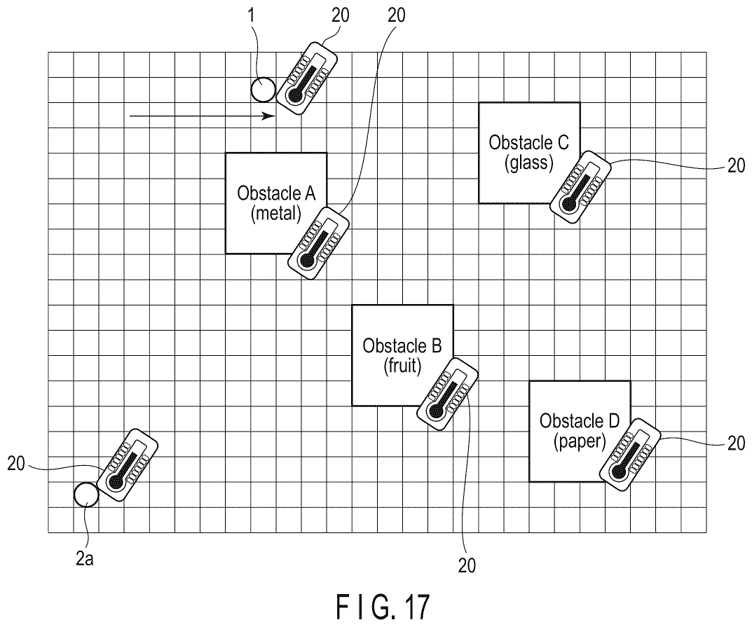

In this case, for example, as illustrated in FIG. 17, temperature (information) of a space in which the obstacle is disposed is acquired, the temperature of the space being measured by a temperature sensor 20 attached to the moving vehicle 1 (a radio device), the antenna 2a installed in the base station 2, and a rack or the like on which each obstacle is disposed, and radio wave transmittance can be calculated using electrical conductivity, dielectric constant, and magnetic permeability with respect to the acquired temperature included in obstacle information. According to such a configuration, it is possible to evaluate a propagation environment of a radio wave using the appropriate radio wave transmittance according to the temperature.

Furthermore, the temperature of a target space may be measured by the temperature sensor 20, and the temperature of a space having an obstacle disposed therein may be represented by the temperature of the target space.

Here, the obstacle information has been described as including the electrical conductivity, the dielectric constant, and the magnetic permeability with respect to the temperature, but the obstacle information may have, for example, a data structure including the electrical conductivity, the dielectric constant, and the magnetic permeability with respect to a frequency. In this case, it is possible to use appropriate radio wave transmittance according to a center frequency used in communication between the moving vehicle 1 and the base station 2.

As described above, the radio wave transmittance of an obstacle can be calculated from the electrical conductivity, the dielectric constant, and the magnetic permeability of the obstacle, but the radio wave transmittance of the obstacle may be determined by classifying the obstacle based on the obstacle information (for example, the electrical conductivity or the like of the obstacle).

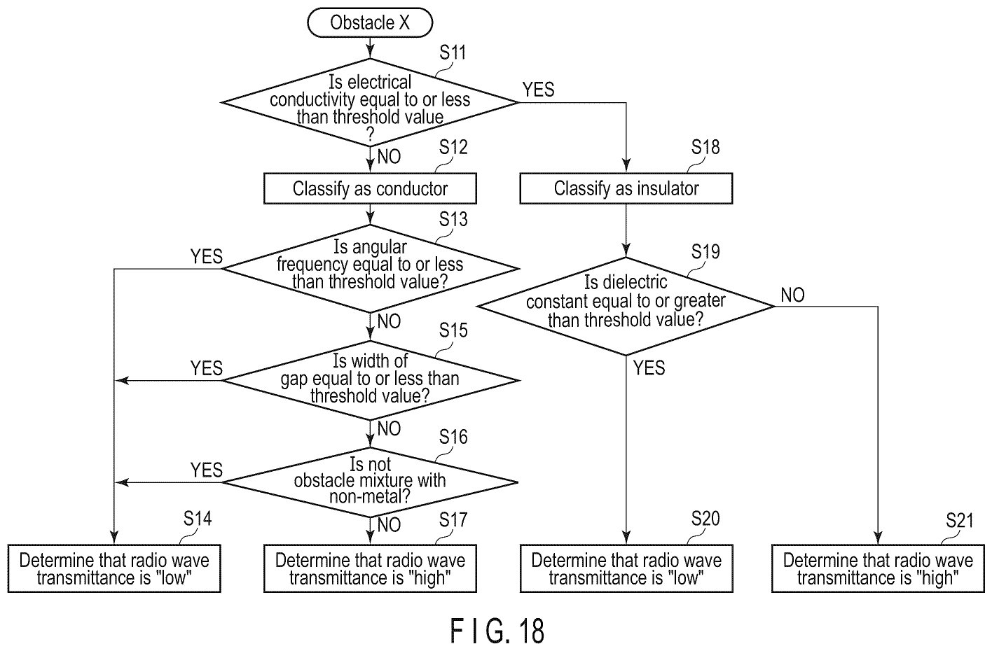

Hereinafter, an example of processing of determining the radio wave transmittance of an obstacle X by classifying the obstacle X will be described with reference to FIG. 18.

First, the obstacle X is classified into a conductor or an insulator depending on the magnitude of electrical conductivity. In this case, it is determined whether the electrical conductivity (σ) of the obstacle X is equal to or less than a threshold value (for example, 10⁵) (step S11).

When it is determined that the electrical conductivity of the obstacle X is not equal to or less than the threshold value (NO in step S11), it is regarded that the obstacle X is a conductor (metal), and the obstacle X is classified as a conductor (step S12). The relative magnetic permeability of the conductor varies, such as 1 for aluminum and 5000 for iron.

Here, since the conductor basically reflects (shields) a radio wave, radio wave transmittance of the conductor is low. However, according to Formula (14) described above, when the angular frequency @ is larger than a threshold value, an absolute value of the dielectric constant & becomes small, and as such the radio wave transmittance becomes high.

Therefore, it is determined whether an angular frequency is equal to or less than a threshold value (step S13). When it is determined that the angular frequency is equal to or less than the threshold value (YES in step S13), it is estimated that the radio wave transmittance of the obstacle X is low, and it is determined that the radio wave transmittance of the obstacle X is “low” (step S14).

In addition, even if the obstacle X is a conductor, the obstacle X may have a configuration in which, for example, conductors (metals) which are components are arranged in a lattice shape. When the width of a gap between the conductors arranged in the lattice pattern in such an obstacle X (hereinafter, referred to as a gap in the obstacle X) is larger than a threshold value, it is considered that the radio wave transmittance of the obstacle X becomes high.

Therefore, when it is determined that the angular frequency is not equal to or less than the threshold value (NO in step S13), it is determined whether the width of (the space of) the gap in the obstacle X is equal to or less than the threshold value (step S15). When it is determined that the width of the gap between the obstacles X is equal to or less than the threshold value (YES in step S15), it is determined that the radio wave transmittance of the obstacle X is “low” in step S14.

Furthermore, when the obstacle X has a configuration as in the case of a half mirror having a surface coated with metal (that is, a mixture of metal and non-metal), the radio wave transmittance of the obstacle X is considered to be high.

Therefore, when it is determined that the width of the gap in the obstacle X is not equal to or less than the threshold value (NO in step S15), it is determined whether (the main component of) the obstacle X is not a mixture of metal and non-metal (step S16). When it is determined that the obstacle X is not a mixture of metal and non-metal (YES in step S16), the radio wave transmittance of the obstacle X is determined to be “low” in step S14.

On the other hand, when it is determined that the obstacle X is a mixture of metal and non-metal (NO in step S16), it cannot be said that the radio wave transmittance of the obstacle X is low, and the radio wave transmittance of the obstacle X is determined to be “high” (step S17).

It is assumed that information (an angular frequency, a width of a gap, whether an obstacle is a mixture, and the like) necessary for executing the processing in steps S13, S15, and S16 described above is prepared in advance as, for example, obstacle information or the like.

When it is determined in step S11 that the electrical conductivity of the obstacle X is equal to or less than the threshold value (YES in step S11), it is regarded that the obstacle X is an insulator (non-metal), and the obstacle X is classified as an insulator (step S18). The relative magnetic permeability of the insulator is 1.

Here, when the dielectric constant (relative dielectric constant) of the obstacle X is equal to or greater than the threshold value, it can be considered that the radio wave transmittance of the obstacle X is low, and when the dielectric constant (the relative dielectric constant) of the obstacle X is less than the threshold value, it can be considered that the radio wave transmittance of the obstacle X is high.

Therefore, it is determined whether the dielectric constant of the obstacle X is equal to or greater than the threshold value (step S19). When it is determined that the dielectric constant of the obstacle X is equal to or greater than the threshold value (YES in step S19), the radio wave transmittance of the obstacle X is determined to be “low” (step S20).

On the other hand, when it is determined that the dielectric constant of the obstacle X is not equal to or greater than the threshold value (NO in step S19), the radio wave transmittance of the obstacle X is determined to be “high” (step S21).

According to FIG. 18 described above, the radio wave transmittance (“low” or “high”) of the obstacle X can be determined. However, in general, in a case where (the main component of) the obstacle X is a conductor (metal), the radio wave transmittance is often low, and a case in which the radio wave transmittance becomes high is limited. Therefore, for example, in a case where highly reliable communication is performed in a radio (radio wave) propagation environment in which a direct wave is dominant, when the electrical conductivity is not equal to or less than the threshold value (that is, the obstacle X is classified as a conductor), steps S13, S15, and S16 may be omitted, and the radio wave transmittance may be determined to be “low”.

In the determination of the radio wave transmittance, a specific numerical value may be determined by providing one or more threshold values instead of “high” and “low”. In the determination of the radio wave transmittance, a numerical value in the case of “high” and a numerical value in the case of “low” may be set, and “high” and “low” may be determined and represented by the numerical value in each case.

In FIG. 18, it has been described that when the obstacle X is an insulator (non-metal), the radio wave transmittance of the obstacle X is determined based on the dielectric constant. However, the radio wave transmittance of the obstacle X may be estimated (determined) from the viewpoint of the reflection coefficient of the obstacle X.

Hereinafter, a method of estimating (determining) the radio wave transmittance of an obstacle from the viewpoint of a reflection coefficient of (the main component of) the obstacle will be described focusing on an insulator (non-metal). It is noted that, although the reflection coefficient will be mainly described here, since “transmission coefficient=1−reflection coefficient” is basically satisfied, a transmission coefficient may be used instead of the reflection coefficient.

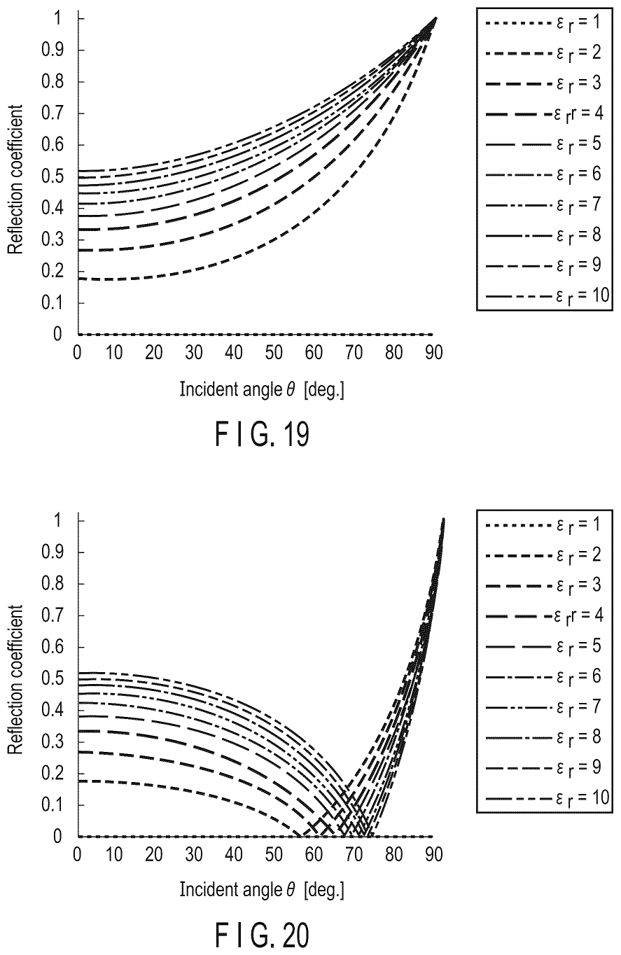

FIGS. 19 and 20 illustrate reflection coefficients of a horizontally polarized wave and a vertically polarized wave calculated based on Formulas (5) and (6) described above using the relative magnetic permeability as 1 and the relative dielectric constant as a parameter. Although there is angle dependency or polarization dependency, for example, in a case where a radio wave hits a medium of εᵣ=10 from the front (that is, the incident angle θ is 0°), the reflection coefficient is approximately 0.5, and half of the radio wave is reflected. Since the amplitude of the transmitted wave is half, it can be seen that the attenuation is 20 log₁₀0.5≈6 dB.

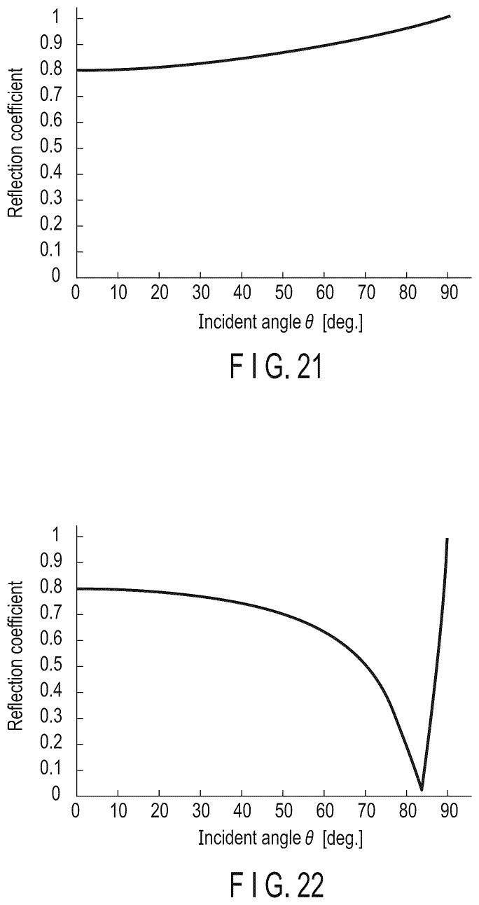

Next, FIGS. 21 and 22 illustrate reflection coefficients of a horizontally polarized wave and a vertically polarized wave calculated using the relative magnetic permeability as 1 and the relative dielectric constant as 81 in an assumption that (the main component of) an obstacle is water. For example, in a case where a cardboard box having apples packed therein is an obstacle, the apples account for slightly less than 90% of moisture, and it can be considered that water is dominant (main component) in the obstacle. Particularly, the horizontally polarized wave has a reflection coefficient of 0.8 or more, and it can be seen that an obstacle having a component mainly containing water (fruit or the like containing a large amount of moisture) easily reflects a radio wave.

In the present embodiment, the radio wave transmittance of the obstacle X may be estimated (determined) in consideration of such a reflection coefficient.

In the present embodiment, for example, it is conceivable to use the above-described reflection coefficient (or the transmission coefficient) as the radio wave transmittance of an obstacle, but for example, the reflection coefficient generally represents a degree of reflection on a surface (that is, a boundary surface between the air and the obstacle X) of the obstacle, and an internal loss occurs in the radio wave actually passing through the obstacle (that is, considering the thickness of the obstacle, the radio wave is further attenuated when the radio wave passes through the obstacle). Therefore, the radio wave transmittance of the obstacle in the present embodiment is preferably estimated (calculated) in consideration of the influence of the internal loss generated in the radio wave to be transmitted through the obstacle with respect to the reflection coefficient (or the transmission coefficient).

As described above, in the present embodiment, information indicating a position of an antenna that radiates a control signal for controlling the moving vehicle 1 by a radio wave, information indicating a position of an obstacle (object) in a target space where the moving vehicle 1 moves, and information indicating radio wave transmittance of an obstacle, the radio wave transmittance indicating a degree of transmission of the radio wave through the object, are acquired, and a propagation environment of the radio wave in the target space is evaluated based on the acquired information indicating the position of the antenna, the acquired information indicating the position of the obstacle, and the acquired information indicating the radio wave transmittance of the obstacle. In the present embodiment, the propagation environment of the radio wave is evaluated for each target region (a region obtained by dividing a target space into a lattice shape).

In the present embodiment, with the above-described configuration, for example, it is possible to easily estimate whether a propagation environment of a radio wave is affected by an obstacle (that is, a dead region generated by the arrangement of the obstacle), and as such it can be said that it is useful for grasping the propagation environment of the radio wave in the target space.

It is noted that, in the present embodiment, for example, a movement plan including a route along which the moving vehicle 1 moves may be managed, and a propagation environment of a radio wave in a region (each region on a route) corresponding to the route included in the movement plan may be evaluated. In such a configuration, for example, in a case where there is an obstacle, the radio wave transmittance of which is less than a predetermined value between a route along which the moving vehicle 1 moves and the antenna 2a installed in the base station 2, a region corresponding to the above-described movement plan (a region on the route facing the antenna 2a with the obstacle interposed between the region and the antenna 2a) can be estimated as a dead region.

That is, in the present embodiment, it is possible to grasp a propagation environment of a radio wave (an intensity of a radio wave from the base station 2) in a region where the moving vehicle 1 moves (is located) using a movement plan or the like grasped in advance.

Further, in the present embodiment, for example, an evaluation result is added to map information indicating a map of a target space, and the map information to which the evaluation result is added is output. A position of an obstacle and radio wave transmittance of the obstacle may be further added to the map information.

In the present embodiment, it is possible to visually and easily grasp an evaluation result (that is, a region estimated as a dead region) of a propagation environment of a radio wave in a target space, for example, by the map information output in this manner.

In other words, according to such map information, it is possible to easily grasp how obstacles disposed in the target space appear as radio waves. Specifically, for example, according to the map information illustrated in FIG. 12, since the radio wave transmittance of each of the obstacles A and B is low, there is a high possibility that the radio wave radiated from the antenna 2a is shielded by the obstacles A and B. That is, in a case where an influence of a direct wave is dominant between transmission and reception, a region on the back side of the obstacles A and B (that is, a region facing the antenna 2a with the obstacles A and B interposed therebetween) is estimated to be a dead region. On the other hand, since the radio wave transmittance of each of the obstacles C and B is high, even if the obstacles C and D are disposed, the obstacles C and D do not become obstacles (radio wave shielding objects) to a radio wave, and it is not estimated that a region on the back side of the obstacles C and D is a dead region. In the present embodiment, as described with reference to FIG. 13, a propagation environment of a radio wave may be evaluated for each target region on a route along which the moving vehicle 1 moves (that is, a region corresponding to a route included in the movement plan).

In the present embodiment, the radio wave transmittance (radio wave transmittance information) of an obstacle used to evaluate the propagation environment of the radio wave in the target space is stored in advance in the storage 42, but the radio wave transmittance of the obstacle can be determined based on, for example, electrical characteristics and magnetic characteristics of the obstacle. In the present embodiment, it is possible to estimate whether the obstacle is the radio wave shielding object by using the radio wave transmittance determined based on the electrical characteristics and the magnetic characteristics of the obstacle as described above.

In the present embodiment, it has been described that the electrical conductivity, the dielectric constant, and the magnetic permeability are used as the electrical characteristics and the magnetic characteristics. However, by quantitatively indicating the electrical characteristics or the magnetic characteristics of the obstacle using the electrical conductivity, the dielectric constant, the magnetic permeability, and the like, the radio wave transmittance of the obstacle can be easily determined (calculated).

In the present embodiment, it has been described that the electrical characteristics and the magnetic characteristics (the electrical conductivity, the dielectric constant, and the magnetic permeability) of an obstacle are used, but the radio wave transmittance may be determined based on the electrical characteristics or the magnetic characteristics of the obstacle. In other words, the electrical characteristics or the magnetic characteristics of the obstacle for determining the radio wave transmittance in this manner may be, for example, at least one of the electrical conductivity, the dielectric constant, and the magnetic permeability of the obstacle.

Further, the radio wave transmittance of an obstacle may be determined based on a reflection coefficient or a transmission coefficient calculated from electrical characteristics or magnetic characteristics of the obstacle. According to such a configuration, since the reflection coefficient or the transmission coefficient is a value in a range of 0 to 1, the reflection coefficient or the transmission coefficient is more easily treated as data than the electrical conductivity, the dielectric constant, and the magnetic permeability, and is useful as a parameter directly linked to the radio wave transmittance.

In addition, it is assumed that an obstacle in the present embodiment is configured by stacking loads such as cardboard boxes disposed in a factory, a warehouse, or the like, but various objects are packed in the cardboard boxes (that is, the obstacle is often a mixture). Therefore, as the radio wave transmittance of an obstacle in the present embodiment, the radio wave transmittance for a dominant substance (that is, a main component) among the substances forming the obstacle is used. According to this configuration, it is possible to reduce the complexity of obtaining the radio wave transmittance in consideration of various substances forming the obstacle.

In the present embodiment, it is sufficient that the radio wave transmittance (the radio wave transmittance information) of an obstacle is stored in the storage 42 in advance as described above, but (at least one of) the electrical conductivity, the dielectric constant, and the magnetic permeability of the obstacle may be stored in the storage 42. In the case of such a configuration, processing of evaluating the propagation environment of the radio wave in the target space using the radio wave transmittance determined (calculated) based on the electrical conductivity, the dielectric constant, and the magnetic permeability of the obstacle stored in the storage 42 may be executed.

Further, in the present embodiment, (a database of) the electrical conductivity, the dielectric constant, and the magnetic permeability of the obstacle may be combined with the movement plan of the moving vehicle 1, the arrangement plan of the obstacle, and the like, simulation of the propagation environment of the radio wave in the target space may be performed in advance with respect to the plan, and the reception power obtained as a result of the simulation may be used for evaluating the propagation environment of the radio wave. In addition, the radio wave transmittance of the obstacle in the present embodiment may be obtained based on the simulation result.

Furthermore, for example, it is also possible to have a configuration in which the radio wave transmittance and the dead region are estimated by setting electrical characteristics or magnetic characteristics of an obstacle and performing simulation. In this case, in order to cope with a dynamic arrangement change of an obstacle in a target space (a factory or a warehouse), a parameter may be simplified and simulated in real time. An accurate simulation may be performed using a high-performance CPU.

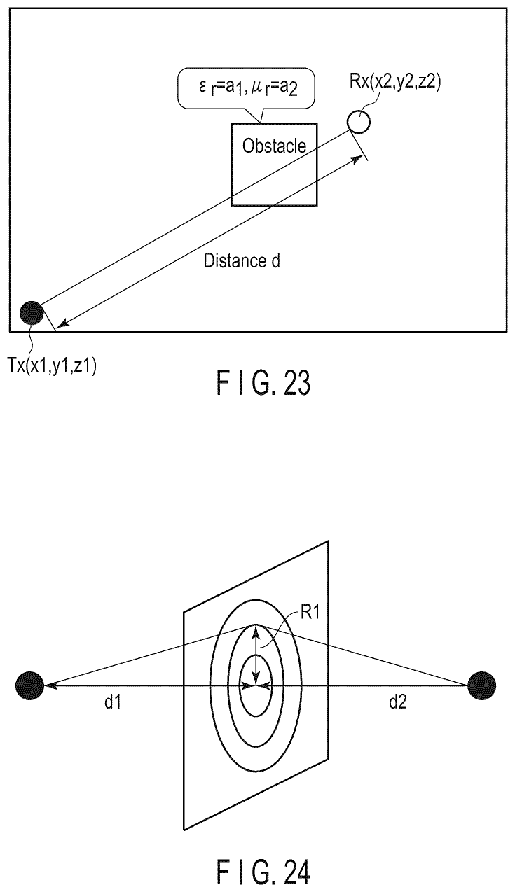

In addition, for example, as illustrated in FIG. 23, for example, coordinate values (x1, y1, z1) of a transmission point Tx and coordinate values (x2, y2, z2) of a reception point Rx defined in the target space may be grasped by the management module 41a, and a dead region may be estimated based on reception power calculated using propagation attenuation calculated from a distance d between the transmission point Tx and the reception point Rx by the propagation formula of the Friis and a transmission coefficient calculated from electrical characteristics and magnetic characteristics of an obstacle (εᵣ=a₁, μᵣ=a₂).

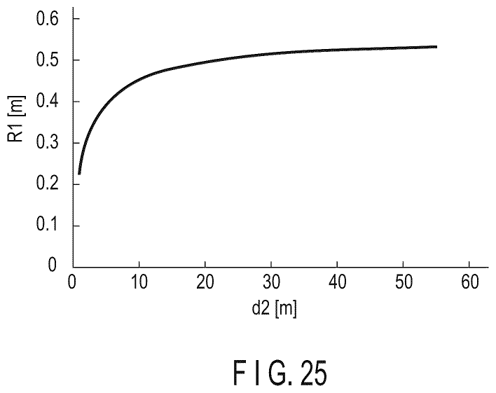

Further, the concept of the Fresnel zone illustrated in FIG. 24 may be used to estimate the dead region. In general, the presence or absence of a line of sight is determined by whether an obstacle exists in the Fresnel zone. If visibility of 60% or more of the radius of the Fresnel zone can be secured, it can be considered that the influence of the obstacle is small. In FIG. 24, when a frequency is 4.9 GHZ and a distance d1 is 5 m, a radius R1 of the Fresnel zone with respect to a distance d2 changes as illustrated in FIG. 25. Assuming that an obstacle exists at the position of the distance d1, since the Fresnel zone is enlarged as the distance d2 increases, the influence of the obstacle becomes relatively small. Therefore, it is considered that as the reception point moves away from the obstacle, the radio wave reaches like line-of-sight communication. In the present embodiment, such a concept may be applied to estimation of the dead region.

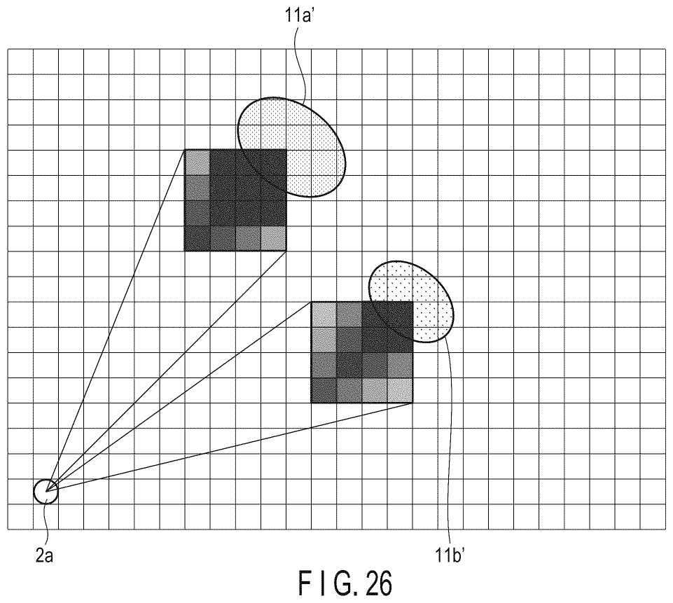

As illustrated in FIGS. 21 and 22, the reflection coefficient (or the transmission coefficient) on the surface of an object (an obstacle) varies depending on the incident angle of a radio wave and a polarized wave of the radio wave. Therefore, the radio wave transmittance of an obstacle may be changed based on the incident angle of the radio wave on the obstacle or the polarized wave in the radio wave. Specifically, for example, focusing on the incident angle of the radio wave, the radio wave transmittance of each of the obstacles A and B illustrated in FIG. 12 can be changed as illustrated in FIG. 26. It is noted that, in FIG. 26, the lighter the color, the higher the radio wave transmittance, and the darker the color, the lower the radio wave transmittance. According to this configuration, as compared with the regions 11a and 11b described as the dead regions in FIG. 12, more appropriate regions 11a′ and 11b′ can be represented (estimated) as dead regions in FIG. 26, thereby making it possible to select a more flexible route in a case where the moving vehicle 1 is controlled to avoid such dead regions.

That is, in the present embodiment, the radio wave transmittance of an obstacle may be determined (changed) based on the incident angle of a radio wave to the obstacle or a polarized wave in the radio wave.

When the radio wave transmittance of the obstacle is determined by the incident angle of the radio wave as described above, it is necessary to know the direction of the obstacle with respect to the antenna 2a that radiates the radio wave. In this case, in a case where an obstacle (such as a cardboard box) is disposed, for example, on a shelf or the like with a fixed orientation, the orientation of the obstacle is fixed. Therefore, the incident angle with respect to the obstacle according to the arrangement can be managed and used in advance. Furthermore, in a case where the radio wave transmittance is determined based on the polarized wave (an incident polarized wave), information on the polarized wave may be managed in advance.

Meanwhile, in the present embodiment, it has been described that the information processing apparatus 4 has the functional configuration illustrated in FIG. 5 and outputs, for example, the map information to which the evaluation result by the evaluation module 41b is added. However, the information processing apparatus 4 may have a function of controlling the moving vehicle 1 based on, for example, the map information. Hereinafter, a description will be given, as a modification of the present embodiment, as to the information processing apparatus (that is, the information processing apparatus configured to be integrated with the moving vehicle control apparatus 3 described above) 4 having a function of controlling the moving vehicle 1. In this case, the information processing apparatus 4 is communicably connected to the moving vehicle 1 moving in the target space via the base station 2. Furthermore, in the present modification, a case in which the information processing apparatus 4 is the MEC is assumed, but the information processing apparatus 4 may be implemented as a server apparatus or the like disposed far from the base station 2 via a network, or may be implemented as a local controller or the like directly connected to the base station 2.

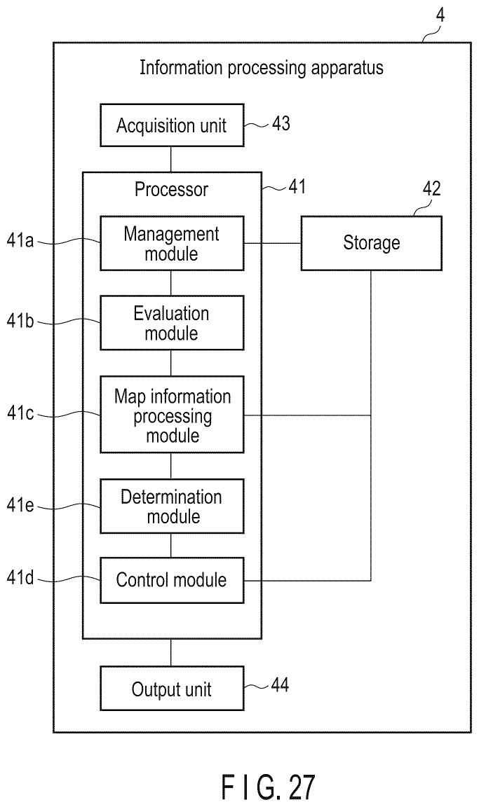

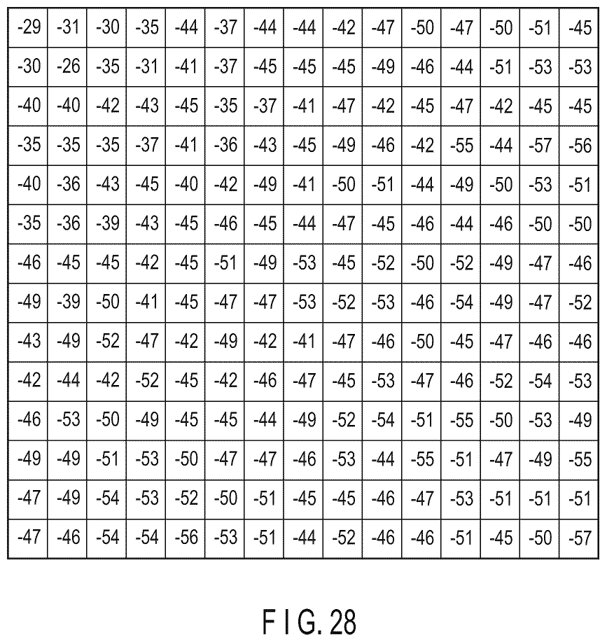

FIG. 27 is a block diagram illustrating an example of a functional configuration of the information processing apparatus 4 according to the present modification. In FIG. 27, the same portions as those in FIG. 5 are denoted by the same reference numerals, and the detailed description thereof will be omitted.

In the present modification, the processor 41 includes a control module 41d and a determination module 41e in addition to the management module 41a, the evaluation module 41b, and the map information processing module 41c described above.

The control module 41d has a function of controlling the moving vehicle 1. Here, an outline of control of the moving vehicle 1 by the control module 41d will be briefly described.

First, the control module 41d generates, for example, a control signal for controlling the moving vehicle 1 such that the moving vehicle 1 moves along all the passages on the map indicated by the map information stored in the storage 42. The control signal generated by the control module 41d in this manner is output (transmitted) from the information processing apparatus 4 (the output unit 44) to the base station 2 and transmitted from the base station 2 to the moving vehicle 1. As a result, the moving vehicle 1 moves entirely in the target space.

Here, for example, in 5G (local 5G), a synchronization signal is broadcasted from the base station 2. The moving vehicle 1 receives the synchronization signal broadcasted from the base station 2 in this manner.

It is assumed that the moving vehicle 1 can measure reception power of the received synchronization signal. The reception power measured by the moving vehicle 1 may be, for example, at least one of received signal strength indicator (RSSI), reference signal received power (RSRP), secondary synchronization signal-reference signal received power (SSS-RSRP), and primary synchronization signal-reference signal received power (PSS-RSRP).

In addition, here, it has been described that the reception power of the synchronization signal broadcasted from the base station 2 is measured, but for example, in 5G (local 5G), a plurality of reference signals such as a channel state information-reference signal (CSI-RS), which is a reference signal for channel information estimation, and a demodulation reference signal (DM-RS), which is a reference signal for demodulation are prepared. Therefore, the reception power may be measured using these reference signals. In this case, the reception power of one reference signal among a plurality of reference signals having different at least one of the frequency, the time, and the antenna may be measured, or an average value of the reception power of each of the plurality of reference signals may be measured.

Furthermore, the moving vehicle 1 is equipped with, for example, an optical distance sensor (a laser range finder (LRF)), and can measure a distance from the moving vehicle 1 to a wall or an obstacle existing around the moving vehicle 1 based on the time (time of flight (TOF)) until laser (light) emitted from the LRF is reflected.

The moving vehicle 1 transmits, to the information processing apparatus 4 via the base station 2, reception power information indicating the reception power measured as described above, distance information indicating a distance, and moving vehicle information indicating a moving speed and a direction of the moving vehicle 1 that has moved based on the control signal. It is noted that the reception power information, the distance information, and the moving vehicle information are transmitted to the information processing apparatus 4 every time the moving vehicle 1 moves (every point in the target space) based on, for example, the control signal.

As described above, the reception power information, the distance information, and the moving vehicle information transmitted from the moving vehicle 1 are received by the base station 2 and output to the information processing apparatus 4. The reception power information, the distance information, and the moving vehicle information output from the base station 2 in this manner are acquired by the acquisition unit 43.

Here, the control module 41d can acquire, based on the distance information and the moving vehicle information, (grasp) the position of the moving vehicle 1 on the map indicated by the map information stored in the storage 42. The control module 41d generates a reception power map (a heat map of the reception power at each point where the moving vehicle 1 is located) obtained by mapping the position of the moving vehicle 1 acquired in this manner and the reception power indicated by the reception power information. Specifically, the control module 41d generates a reception power map (a radio wave map indicating a propagation environment of a radio wave in a target space) by allocating, to the point, the reception power measured at each point by the movement of the moving vehicle 1 (that is, by associating the point and the reception power with each other).

For convenience, for example, FIG. 28 illustrates an example of the reception power map generated by the moving vehicle 1 moving in a planar manner in a target space where no obstacle is disposed. According to such a reception power map, it is possible to grasp, for example, a route or the like along which the moving vehicle 1 moves in a region where the reception power is not reduced.

In the processing of generating the reception power map, the distance information and the moving vehicle information are used to acquire a point (a position) to which the reception power indicated by the reception power information is allocated, but the distance information and the moving vehicle information may be further used to update the map information (that is, the arrangement of obstacles on the map, and the like) stored in the storage 42.

In addition, although it has been described here that the reception power map is generated based on the reception power of the downlink signal (the synchronization signal), in general, since there is reciprocity (a symmetrical relationship) between the downlink and the uplink in wireless communication, the reception power map may be generated based on the reception power of the uplink signal, or may be generated based on a result of merging the reception power of the downlink signal and the reception power of the uplink signal.

In addition, here, a map in which a signal throughput and a bit error rate are allocated to each point on the map may be generated instead of the reception power map as long as the propagation environment of the radio wave in the target space can be grasped.

It is noted that, although detailed description is omitted here, the map information stored in the storage 42 may be generated, for example, by updating an initial layout of a target space (map information representing only a wall and a passage) based on the distance information and the moving vehicle information described above.

In the present modification, the control module 41d controls the moving vehicle 1 moving in the target space using the map information and the reception power map described above. Specifically, the control module 41d performs cost calculation considering reception power at a point (a space) overlapping each of a plurality of routes from a start point to a goal point set on the map indicated by the map information, and selects an optimum route from among the plurality of routes based on a result of the cost calculation.

The control module 41d generates a control signal for controlling the moving vehicle 1 such that the moving vehicle 1 moves along a route (hereinafter, referred to as a target route) selected in this manner, and transmits the generated control signal to the moving vehicle 1 via the base station 2 at regular intervals. In this case, movement plan information indicating a movement plan including the target route is generated, and the movement plan information is stored in the storage 42.

Here, it is assumed that an obstacle is disposed in the target space and the above-described processing illustrated in FIG. 7 is executed. In this case, the determination module 41e acquires the map information output from the map information processing module 41c.

The determination module 41e determines, based on the acquired map information, whether an obstacle exists in a line segment connecting the antenna installed in the base station 2 to each point (position) on the route which is selected by the control module 41d and along which the moving vehicle 1 moves (that is, between an antenna and a route).

When it is determined that an obstacle exists, the determination module 41e determines whether the radio wave transmittance of the obstacle (hereinafter, referred to as a target obstacle) satisfies the following first to third conditions.

The first condition includes that the radio wave transmittance of the target obstacle is less than a first threshold value (a predetermined first value). The second condition includes that the radio wave transmittance of the target obstacle is equal to or greater than the first threshold value and less than a second threshold value (a predetermined second value). The third condition includes that the radio wave transmittance of the target obstacle is equal to or greater than the second threshold value. Here, it is assumed that the radio wave transmittance of the target obstacle is a numerical value in the range of 0 to 1. The first and second threshold values are predetermined values in the range of 0 to 1, and have a relationship that the first threshold value is less than the second threshold value.

When the radio wave transmittance of the target obstacle is represented by, for example, “low”, “medium”, and “high”, the first condition may be that the radio wave transmittance of the target obstacle is “low”, the second condition may be that the radio wave transmittance of the target obstacle is “medium”, and the third condition may be that the radio wave transmittance of the target obstacle is “high”.

First, it is assumed that the determination module 41e determines that the first condition is satisfied. In the present modification, “satisfying the first condition” means that the target obstacle causes the propagation environment of the radio wave to deteriorate (at each point) on the target route (that is, the target obstacle shields the radio wave to the target route) to such an extent that the moving vehicle 1 cannot move along the target route. In this case, the control module 41d changes the target route to another route. Specifically, the control module 41d deletes the target route from the movement plan indicated by the movement plan information stored in the storage 42, and adds a route changed from the target route to the movement plan. In addition, the control module 41d generates a control signal for controlling the moving vehicle 1 such that the moving vehicle 1 moves along the route added to the movement plan. The control signal generated in this manner is transmitted to the moving vehicle 1 via the output unit 44. According to this configuration, the moving vehicle 1 can be controlled according to the movement plan changed based on the radio wave transmittance of the obstacle.

Next, it is assumed that the determination module 41e determines that the second condition is satisfied. In the present modification, “satisfying the second condition” means that the moving vehicle 1 can move along the target route, but the target obstacle may affect the propagation environment of the radio wave (at each point) on the target route. In this case, the control module 41d is operated so as to increase a control cycle for the moving vehicle 1 without changing the target route described above. Specifically, for example, when an interval at which the control signal is transmitted when the propagation environment of the radio wave is good is a first interval, the control module 41d changes the first interval to a second interval shorter than the first interval. According to this configuration, for example, even if a situation occurs in which it is difficult to temporarily receive the control signal in the target route, it is possible to prevent the moving vehicle 1 from becoming uncontrollable.

Further, when the determination module 41e determines that the third condition is satisfied, since the propagation environment of the radio wave on the target route is good, the control module 41d may continuously control the moving vehicle 1 such that the moving vehicle 1 moves along the target route. The control signal in this case is transmitted to the moving vehicle 1 at the first interval.

In the present modification, a risk of passing through corresponding to the radio wave transmittance of the obstacle described above may be set in, for example, the reception power map or the like. According to such a reception power map, for example, it is possible to prevent selection of a route passing through a region on the back side of an obstacle (a region estimated to be a dead region and located directly behind a straight line connecting an obstacle having low radio wave transmittance to an antenna) having the radio wave transmittance less than the first threshold value when viewed from the antenna.

In addition, there is a possibility that reception power decreases in the vicinity of an edge of a coverage area of the base station 2. Therefore, for example, when the route is changed as described above, the moving vehicle 1 may be controlled so as not to move in the vicinity of the edge of the coverage area.

As described above, in the present modification, a movement plan including a route along which the moving vehicle 1 moves is managed, whether an obstacle, the radio wave transmittance of which is less than the first threshold value, exists between the route included in the movement plan and the antenna is determined, and when it is determined that the obstacle exists therebetween, the route included in the movement plan is changed, and the moving vehicle 1 is controlled according to the movement plan including the changed route.

In the present modification, by controlling the moving vehicle 1 based on the radio wave transmittance of the obstacle in this manner, it is possible to avoid a situation in which the moving vehicle 1 moves in a dead region (a region estimated to be a dead region) and cannot normally receive a control signal (that is, control of the moving vehicle 1 becomes impossible). In other words, in the case of a configuration in which a route along which the moving vehicle 1 moves is simply selected with reference to reception power map, occurrence (presence) of a dead region cannot be grasped unless reception power is measured by causing the moving vehicle 1 to move in the dead region. However, in the present modification, a dead region (that is, a propagation environment of a radio wave in a target space) can be grasped without causing the moving vehicle 1 to move in the dead region, and the moving vehicle 1 can be controlled to avoid the dead region.

It is noted that, in the present modification, it has been described that a route is changed when there is an obstacle, the radio wave transmittance of which is less than a threshold value, between the route included in a movement plan and an antenna. However, in the present modification, the moving vehicle 1 may be controlled to avoid a dead region based on map information to which an evaluation result (that is, an evaluation result indicating that a predetermined region is the dead region) of the propagation environment of the radio wave in the target space is added.

Meanwhile, in the present modification, the configuration has been described in which a route is changed according to an obstacle, the radio wave transmittance of which is less than the first threshold value. However, for example, instead of changing the route, the arrangement of the obstacle in the target space may be changed based on the radio wave transmittance.

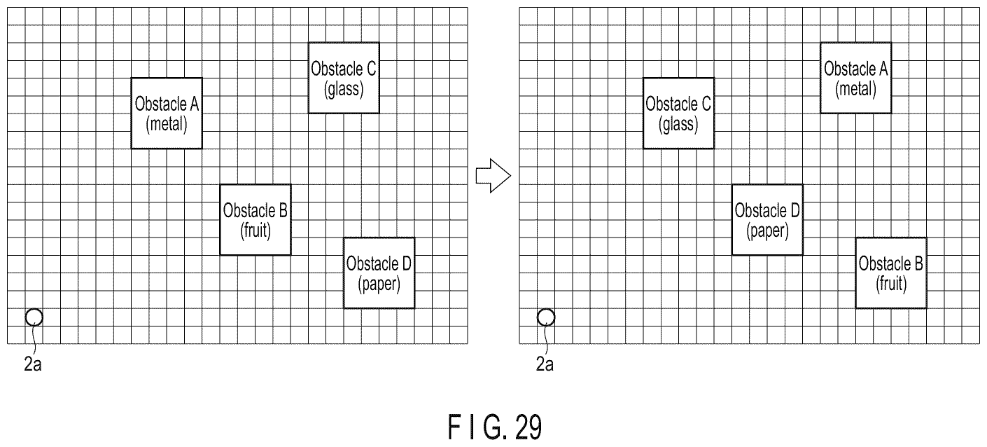

Specifically, for example, as illustrated in FIG. 29, by changing the arrangement of the obstacles A to D, in a case where the obstacles A and B, the radio wave transmittance of which is low, described in FIGS. 11 and 12 are disposed far from the antenna 2a (that is, the vicinity of the edge of the coverage area of the base station 2), it is possible to increase a range in which the moving vehicle 1 can move while avoiding a region estimated as a dead region on the back side of the obstacles A and B.

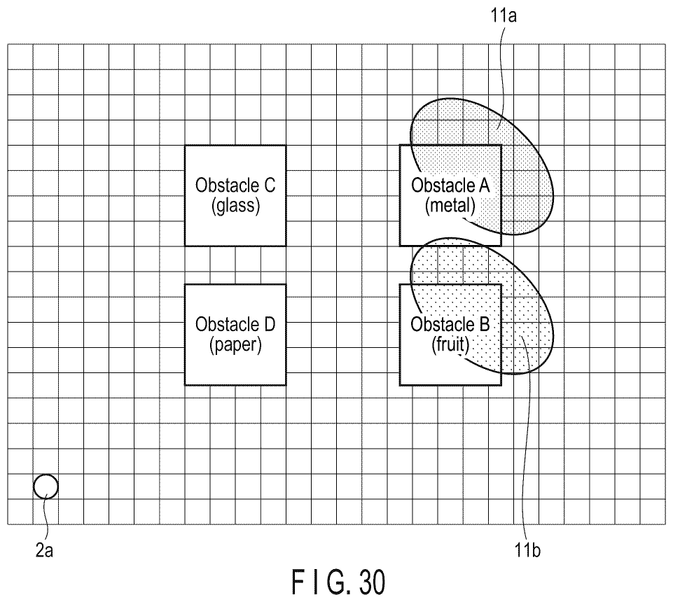

Furthermore, for example, if there is no restriction on a position where an obstacle (a load such as a cardboard box) is disposed, the positions of regions 11a and 11b estimated as the dead regions (regions on the back side of the obstacles A and B) may be freely changed by moving the obstacles A and B, for example, as illustrated in FIG. 30. In this case, the regions 11a and 11b may be set as non-movable regions, and the moving vehicle 1 may be controlled so as not to move in the regions 11a and 11b.

It is noted that the above-described change in the arrangement of the obstacles can be realized, for example, by instructing, from the information processing apparatus 4 (the processor 41), the moving vehicle 1 to carry the obstacle (the load). In addition, the arrangement of the obstacles may be manually changed, for example, by giving an instruction to an administrator or the like of the information processing apparatus 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

[1]

An information processing apparatus including a processor configured to:
acquire information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluate a propagation environment of the radio wave in the space based on the acquired information indicating the position of the antenna, the acquired information indicating the position of the object, and the acquired information indicating the radio wave transmittance of the object.
   [2]

The information processing apparatus according to [1], wherein the processor is configured to evaluate the propagation environment of the radio wave for each region obtained by dividing the space into a lattice shape.

[3]

The information processing apparatus according to [1] or [2], wherein the processor is configured to estimate, based on an evaluation result, a region in the space, the region having reception power equal to or less than a predetermined value.

[4]

The information processing apparatus according to any one of [1] to [3], wherein the processor is configured to evaluate the propagation environment of the radio wave in a region corresponding to a route along which the moving vehicle moves.

[5]

The information processing apparatus according to [4], wherein the processor is configured to estimate, when the object, the radio wave transmittance of which is less than a predetermined value, exists between the route along which the moving vehicle moves and the antenna, the region corresponding to the route along which the moving vehicle moves as a region having reception power equal to or less than a predetermined value.

[6]

The information processing apparatus according to any one of [1] to [5], wherein the processor is configured to add an evaluation result to map information indicating a map of the space, and outputs the map information having the evaluation result added thereto.

[7]

The information processing apparatus according to [6], wherein the acquired information indicating the position of the object and the acquired information indicating the radio wave transmittance of the object are further added to the map information to be output.

[8]

The information processing apparatus according to any one of [1] to [7], further including a storage configured to store, in advance, the information indicating the radio wave transmittance of the object disposed in the space,
wherein the processor is configured to acquire, from the storage, the information indicating the radio wave transmittance of the object.
   [9]

The information processing apparatus according to any one of [1] to [8], wherein the radio wave transmittance of the object is determined based on an electrical characteristic or a magnetic characteristic of the object.

[10]

The information processing apparatus according to [9], wherein the electrical characteristic or the magnetic characteristic includes at least one of electrical conductivity, dielectric constant, and magnetic permeability of the object.

[11]

The information processing apparatus according to [9] or [10], wherein the radio wave transmittance of the object is determined based on a reflection coefficient or a transmission coefficient calculated from the electrical characteristic or the magnetic characteristic of the object.

[12]

The information processing apparatus according to any one of [1] to [11], wherein the radio wave transmittance of the object includes the radio wave transmittance of a substance having a predetermined ratio or more among the substances forming the object.

[13]

The information processing apparatus according to any one of [1] to [12], wherein the radio wave transmittance of the object is determined based on an incident angle of the radio wave to the object or a polarized wave of the radio wave.

[14]

The information processing apparatus according to any one of [1] to [13], wherein the processor is configured to:
determine whether the object, the radio wave transmittance of which is less than a predetermined value, exists between a route along which the moving vehicle moves and the antenna;
change the route upon determining that the object exists therebetween; and
control the moving vehicle such that the moving vehicle moves along the changed route.
   [15]

The information processing apparatus according to any one of [1] to [14], wherein the processor is configured to issue, based on the acquired information indicating the radio wave transmittance of the object, an instruction to change an arrangement of the object in the space.

[16]

A system including:
the information processing apparatus according to any one of [1] to; and
a moving vehicle communicably connected to the information processing apparatus,
in which the moving vehicle is controlled based on an evaluation result.
   [17]

A method including:
acquiring information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluating a propagation environment of the radio wave in the space based on the acquired information indicating the position of the antenna, the acquired information indicating the position of the object, and the acquired information indicating the radio wave transmittance of the object.
   [18]

A non-transitory computer-readable storage medium having stored thereon a program which is executed by a computer of an information processing apparatus, the program including instructions capable of causing the computer to execute functions of:
acquiring information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluating a propagation environment of the radio wave in the space based on the acquired information indicating the position of the antenna, the acquired information indicating the position of the object, and the acquired information indicating the radio wave transmittance of the object.

What is claimed is:

1. An information processing apparatus comprising a processor configured to:
acquire information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluate a propagation environment of the radio wave in the space based on the acquired information indicating the position of the antenna, the acquired information indicating the position of the object, and the acquired information indicating the radio wave transmittance of the object.

2. The information processing apparatus according to claim 1, wherein the processor is configured to evaluate the propagation environment of the radio wave for each region obtained by dividing the space into a lattice shape.

3. The information processing apparatus according to claim 1, wherein the processor is configured to estimate, based on an evaluation result, a region in the space, the region having reception power equal to or less than a predetermined value.

4. The information processing apparatus according to claim 1, wherein the processor is configured to evaluate the propagation environment of the radio wave in a region corresponding to a route along which the moving vehicle moves.

5. The information processing apparatus according to claim 4, wherein the processor is configured to estimate, when the object, the radio wave transmittance of which is less than a predetermined value, exists between the route along which the moving vehicle moves and the antenna, the region corresponding to the route along which the moving vehicle moves as a region having reception power equal to or less than a predetermined value.

6. The information processing apparatus according to claim 1, wherein the processor is configured to add an evaluation result to map information indicating a map of the space, and outputs the map information having the evaluation result added thereto.

7. The information processing apparatus according to claim 6, wherein the acquired information indicating the position of the object and the acquired information indicating the radio wave transmittance of the object are further added to the map information to be output.

8. The information processing apparatus according to claim 1, further comprising a storage configured to store, in advance, the information indicating the radio wave transmittance of the object disposed in the space,
wherein the processor is configured to acquire, from the storage, the information indicating the radio wave transmittance of the object.

9. The information processing apparatus according to claim 1, wherein the radio wave transmittance of the object is determined based on an electrical characteristic or a magnetic characteristic of the object.

10. The information processing apparatus according to claim 9, wherein the electrical characteristic or the magnetic characteristic includes at least one of electrical conductivity, dielectric constant, and magnetic permeability of the object.

11. The information processing apparatus according to claim 9, wherein the radio wave transmittance of the object is determined based on a reflection coefficient or a transmission coefficient calculated from the electrical characteristic or the magnetic characteristic of the object.

12. The information processing apparatus according to claim 1, wherein the radio wave transmittance of the object includes the radio wave transmittance of a substance having a predetermined ratio or more among the substances forming the object.

13. The information processing apparatus according to claim 1, wherein the radio wave transmittance of the object is determined based on an incident angle of the radio wave to the object or a polarized wave of the radio wave.

14. The information processing apparatus according to claim 1, wherein the processor is configured to:
determine whether the object, the radio wave transmittance of which is less than a predetermined value, exists between a route along which the moving vehicle moves and the antenna;
change the route upon determining that the object exists therebetween; and
control the moving vehicle such that the moving vehicle moves along the changed route.

15. The information processing apparatus according to claim 1, wherein the processor is configured to issue, based on the acquired information indicating the radio wave transmittance of the object, an instruction to change an arrangement of the object in the space.

16. A system comprising:
the information processing apparatus according to claim 1; and
a moving vehicle communicably connected to the information processing apparatus,
wherein the moving vehicle is controlled based on the evaluation result.

17. A method comprising:
acquiring information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluating a propagation environment of the radio wave in the space based on the acquired information indicating the position of the antenna, the acquired information indicating the position of the object, and the acquired information indicating the radio wave transmittance of the object.

18. A non-transitory computer-readable storage medium having stored thereon a program which is executed by a computer of an information processing apparatus, the program comprising instructions capable of causing the computer to execute functions of:
acquiring information indicating a position of an antenna that radiates a control signal for controlling a moving vehicle using a radio wave, information indicating a position of an object in a space in which the moving vehicle moves, and information indicating radio wave transmittance of the object, the radio wave transmittance indicating a degree of transmission of the radio wave through the object; and
evaluating a propagation environment of the radio wave in the space based on the acquired information indicating the position of the antenna, the acquired information indicating the position of the object, and the acquired information indicating the radio wave transmittance of the object.
